(19) United States
(12) Patent Application Publication
(10) Pub. No.: US 2025/0184918 A1
(43) Pub. Date: Jun. 5, 2025

(54) UPLINK TRANSMISSION SCHEDULING FOR SCHEDULING EFFICIENCY AND RELIABILITY

(71) Applicant: QUALCOMM Incorporated, San Diego, CA (US)

(72) Inventor: Gene FONG, San Diego, CA (US)

(21) Appl. No.: 18/525,777

(22) Filed: Nov. 30, 2023

(51) Int. Cl. H04W 52/36; H04W 52/42; H04W 72/0453; H04W 72/1268; H04W 84/06

(52) U.S. Cl. CPC H04W 52/367; H04W 52/42; H04W 72/0453; H04W 72/1268; H04W 84/06

(57) ABSTRACT

A UE may transmit, to a network node, additional maximum power reduction (A-MPR) information associated with the UE for a waveform; and communicate with the network node based on the A-MPR information associated with the UE. A UE may transmit, to a network node, an indication of support for an increased power class for a subset of waveforms; and receive, from the network node, scheduling information for a waveform in the subset of waveforms, the scheduling information indicating frequency resources in an additional maximum power reduction (A-MPR) region of the waveform based on the support for the increased power class.

### INTRODUCTION

The present disclosure relates generally to communication systems, and more particularly, to wireless communication including scheduling for uplink transmissions.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some aspects, the techniques described herein relate to a method of wireless communication at a user equipment (UE), including: transmitting, to a network node, additional maximum power reduction (A-MPR) information associated with the UE for one or more waveforms; and communicating with the network node based on the A-MPR information associated with the UE.

In some aspects, the techniques described herein relate to an apparatus for wireless communication at a UE, including: one or more memories; and one or more processors coupled to the one or more memories and configured to cause the UE to: transmit, to a network node, A-MPR information associated with the UE for one or more waveforms; and communicate with the network node based on the A-MPR information associated with the UE.

In some aspects, the techniques described herein relate to an apparatus for wireless communication at a UE, including: means for transmitting, to a network node, A-MPR information associated with the UE for one or more waveforms; and means for communicating with the network node based on the A-MPR information associated with the UE.

In an aspect of the disclosure, a computer-readable medium is provided for wireless communication at a UE. The computer-readable medium includes code, which when executed by one or more processors, causes the UE to transmit, to a network node, A-MPR information associated with the UE for one or more waveforms; and communicate with the network node based on the A-MPR information associated with the UE.

In some aspects, the techniques described herein relate to a method of wireless communication at a UE, including: transmitting, to a network node, an indication of support for an increased power class for a subset of waveforms; and receiving, from the network node, scheduling information for a waveform in the subset of waveforms, the scheduling information indicating frequency resources in an A-MPR region of the waveform based on the support for the increased power class.

In some aspects, the techniques described herein relate to an apparatus for wireless communication at a UE, including: one or more memories; and one or more processors coupled to the one or more memories and configured to cause the UE to: transmit, to a network node, an indication of support for an increased power class for a subset of waveforms; and receive, from the network node, scheduling information for a waveform in the subset of waveforms, the scheduling information indicating frequency resources in an A-MPR region of the waveform based on the support for the increased power class.

In some aspects, the techniques described herein relate to an apparatus for wireless communication at a UE, including: means for transmitting, to a network node, an indication of support for an increased power class for a subset of waveforms; and means for receiving, from the network node, scheduling information for a waveform in the subset of waveforms, the scheduling information indicating frequency resources in an A-MPR region of the waveform based on the support for the increased power class.

In an aspect of the disclosure, a computer-readable medium is provided for wireless communication at a UE. The computer-readable medium includes code, which when executed by one or more processors, causes the UE to transmit, to a network node, an indication of support for an increased power class for a subset of waveforms; and receive, from the network node, scheduling information for a waveform in the subset of waveforms, the scheduling information indicating frequency resources in an A-MPR region of the waveform based on the support for the increased power class.

In some aspects, the techniques described herein relate to a method of wireless communication at a network node, including: obtaining A-MPR information associated with a UE for one or more waveforms; and scheduling communication from the UE based on the A-MPR information associated with the UE.

In some aspects, the techniques described herein relate to an apparatus for wireless communication at a network node, including: one or more memories; and one or more processors coupled to the one or more memories and configured to cause the network node to: obtain A-MPR information associated with a UE for one or more waveforms; and schedule communication from the UE based on the A-MPR information associated with the UE.

In some aspects, the techniques described herein relate to an apparatus for wireless communication at a network node, including: means for obtaining A-MPR information associated with a UE for one or more waveforms; and means for scheduling communication from the UE based on the A-MPR information associated with the UE.

In an aspect of the disclosure, a computer-readable medium is provided for wireless communication at a network node. The computer-readable medium includes code, which when executed by one or more processors, causes the network node to obtain A-MPR information associated with a UE for one or more waveforms; and schedule communication from the UE based on the A-MPR information associated with the UE.

In some aspects, the techniques described herein relate to a method of wireless communication at network node, including: obtaining an indication of support of a UE for an increased power class for a subset of waveforms; and scheduling, based on the support for the increased power class, communication from the UE in frequency resources in an A-MPR region of the frequency resources for the waveform.

In some aspects, the techniques described herein relate to an apparatus for wireless communication at a network node, including: one or more memories; and one or more processors coupled to the one or more memories and configured to cause the network node to: obtain an indication of support of a UE for an increased power class for a subset of waveforms; and schedule, based on the support for the increased power class, communication from the UE in frequency resources in an A-MPR region of the frequency resources for a waveform.

In some aspects, the techniques described herein relate to an apparatus for wireless communication at network node, including: means obtaining an indication of support of a UE for an increased power class for a subset of waveforms; and means for scheduling, based on the support for the increased power class, communication from the UE in frequency resources in an A-MPR region of the frequency resources for the waveform.

In an aspect of the disclosure, a computer-readable medium is provided for wireless communication at a network node. The computer-readable medium includes code, which when executed by one or more processors, causes the network node to obtain an indication of support of a UE for an increased power class for a subset of waveforms; and schedule, based on the support for the increased power class, communication from the UE in frequency resources in an A-MPR region of the frequency resources for a waveform.

In some aspects, the techniques described herein relate to a method of wireless communication at a network node, including: scheduling communication from a UE with repetition based on an A-MPR region of frequency resources for a waveform; and obtaining the communication with the repetition.

In some aspects, the techniques described herein relate to an apparatus for wireless communication at a network node, including: one or more memories; and one or more processors coupled to the one or more memories and configured to cause the network node to: schedule communication from a UE with repetition based on an A-MPR region of frequency resources for a waveform; and obtain the communication with the repetition.

In some aspects, the techniques described herein relate to an apparatus for wireless communication at a network node, including: means for scheduling communication from a UE with repetition based on an A-MPR region of frequency resources for a waveform; and means for obtaining the communication with the repetition.

In an aspect of the disclosure, a computer-readable medium is provided for wireless communication at a network node. The computer-readable medium includes code, which when executed by one or more processors, causes the network node to schedule communication from a UE with repetition based on an A-MPR region of frequency resources for a waveform; and obtain the communication with the repetition.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 is a diagram illustrating an example of a wireless communications system and an access network including aspects of a disaggregated base station.

FIG. 3A is a diagram illustrating an example of a first subframe within a 5G NR frame structure, in accordance with various aspects of the present disclosure.

FIG. 3B is a diagram illustrating an example of downlink (DL) channels within a 5G NR subframe, in accordance with various aspects of the present disclosure.

FIG. 3C is a diagram illustrating an example of a second subframe within a 5G NR frame structure, in accordance with various aspects of the present disclosure.

FIG. 3D is a diagram illustrating an example of uplink (UL) channels within a 5G NR subframe, in accordance with various aspects of the present disclosure.

FIG. 4 is a block diagram illustrating an example of a base station in communication with a UE in an access network, in accordance with various aspects of the present disclosure.

FIG. 5 is a diagram illustrating example aspects of a non-terrestrial network (NTN).

FIG. 6A, FIG. 6B, and FIG. 6C are diagrams illustrating example network architectures capable of supporting NTN access.

FIG. 7 is a graph showing A-MPR regions and a non-A-MPR region for a waveform, in accordance with aspects presented herein.

FIG. 8 is a diagram illustrating example aspects of a NTN and a terrestrial network.

FIG. 9 is a communication flow between a UE and a network node including the scheduling based on UE specific A-MPR information, in accordance with aspects presented herein.

FIG. 10 is a communication flow between a UE and a network node including frequency allocation based repetition, in accordance with aspects presented herein.

FIG. 11 is a communication flow between a UE and a network node including the scheduling based on power class for a waveform, in accordance with aspects presented herein.

FIG. 12 is a flowchart of a method of wireless communication at a UE, in accordance with aspects presented herein.

FIG. 13 is a flowchart of a method of wireless communication at a UE, in accordance with aspects presented herein.

FIG. 14 is a flowchart of a method of wireless communication at a network node, in accordance with aspects presented herein.

FIG. 15 is a flowchart of a method of wireless communication at a network node, in accordance with aspects presented herein.

FIG. 16 is a flowchart of a method of wireless communication at a network node, in accordance with aspects presented herein.

FIG. 17 is a diagram illustrating an example of a hardware implementation for an example apparatus and/or UE, in accordance with aspects presented herein.

FIG. 18 is a diagram illustrating an example of a hardware implementation for an example network entity, in accordance with aspects presented herein.

### DETAILED DESCRIPTION

A link budget provides an accounting of power gains and losses that a communication signal experiences based on a transmission power, and the link budget can be used to calculate an anticipated received signal at a receiver. The link budget is affected by propagation path loss and bandwidth, among other factors. An NTN link budget, such as for an uplink signal from a terrestrial UE to a satellite, can be challenging due to the limited transmission power available from the UE and the large propagation distance to the satellite. An increased transmission power from the UE can improve the link budget, yet the available UE transmit power may be limited based on emissions requirements, which may also be referred to as emission limits. In order to meet the emissions requirements, the UE may employ a maximum power reduction (MPR) power backoff to reduce a transmission power at the UE. Some frequency bands may have additional emission requirements beyond the general requirements. An additional power backoff may be allowed and may be referred to as additional maximum power reduction (A-MPR). As an example, in the LS band (e.g., 1610-1626.5 MHz uplink (UL)), there may be protection for frequencies below the band to protect nearby Global Navigation Satellite System (GNSS) operation. The LS band is merely an example to illustrate the concept, and the aspects may be similarly applicable for other frequency bands. MPR and A-MPR may reduce the available transmit power for a UE below a maximum transmit power level. As an example, with a reduction based on an A-MPR of 3 dB, a maximum available transmission power for a waveform may be reduced to 20 dBm rather than the maximum 23 dBm power for PC3. For uplink link budgets, such as an NTN link budget that involves large distances of propagation delay, additional power back off, e.g., reductions in maximum transmission power due to A-MPR, can reduce achievable data rates.

A terrestrial network may schedule frequency resources for UEs based on their location within cell coverage (a cell center coverage, a mid-cell coverage, a cell-edge coverage) by scheduling UEs that are closer to a cell-edge area/region with frequency resources without A-MPR and UEs that are closer to a cell center with frequency resources with A-MPR. For example, the UE's closer to the cell edge can transmit with a higher power due to the allocation of resources without a reduction due to A-MPR, while the network is more likely to accurately receive communication from the UE's that are closer to the cell center even with a reduction in transmission power due to A-MPR. Due to the distance between the satellite and the surface of the Earth, each UE served by a satellite may be considered to be located at or near a cell edge of the NTN, and a reduction in transmission power due to A-MPR is likely to affect the network's reception of the uplink transmissions from the UEs. If the NTN schedules each UE with resources that do not have an A-MPR, the resources available for scheduling are reduced, e.g., limited to the frequency resources that are not affected by the power reduction requirements of A-MPR. If the NTN schedules the UEs using a broader set of frequency resources that includes resources subject to A-MPR, the uplink transmissions from some UEs may not be accurately received at the satellite due to the transmission power reductions based on the A-MPR. Aspects presented herein help to maintain the quality of service provided by wireless networks while making a more efficiency use of scheduling resources. For example, the aspects presented herein may improve the efficient use of scheduling resources for NTNs.

In some aspects, an A-MPR table may be specified, or defined, for a waveform in a wireless standard. As the defined table is to apply to various types of UEs, in one example, the A-MPR resources may be defined based on the UEs that are most affected by A-MPR, e.g., the UE's for which communication is improved through a power reduction based on A-MPR. Other UEs may be designed with an “actual A-MPR” that differs from the defined A-MPR in the wireless standard. The UE's actual A-MPR may be referred as a “UE specific A-MPR,” in contrast to the defined A-MPR that is applicable for multiple UEs. For example, a first UE may support a first A-MPR for a particular waveform, a second UE may support a second, different A-MPR for the same waveform, and one or more of the first A-MPR and the second A-MPR may be different than an A-MPR defined in the wireless standard for the waveform. For example, the UE specific A-MPR may include an expanded set of non-A-MPR frequency resources (e.g., larger than a minimum set of resources in the defined A-MPR table). As presented herein, a UE may signal its UE specific A-MPR to a network node, and the network node may schedule the UE, e.g., allocate frequency resources for transmissions by the UE, based on the UE-specific A-MPR. As the UE specific A-MPR may include an expanded set of frequency resources without A-MPR, the network node may schedule the UE based on a broader set of frequency resources, which improves scheduling efficiency while continuing to meet emissions requirements and maintain accurate communication with a wireless network such as an NTN, among other examples. The use of UE specific A-MPR information enables a broader frequency band service to be provided to UEs, allowing for an increased data rate and richer diversity of service.

In some aspects, the network node may schedule repetitions of uplink transmissions that are targeted for UEs scheduled in frequency resources within an A-MPR region of frequency resources for a waveform. An “A-MPR” region refers to a subset (such as a subset of frequency resources) of resources that are subject to an A-MPR. A “non-A-MPR region” refers to a subset (e.g., a subset of frequency resources) of resources that are not subject to A-MPR. A “waveform” can be based on a combination of one or more of a modulation and a signal type for a wireless signal. In addition to the modulation and type, the “waveform” may further be based on the starting resource block (RB) and length of allocation for the wireless signal. In some aspects, the “waveform” may be based on a combination of the modulation, type, starting RB and length of resource allocation for the wireless signal. For example, the modulation may be binary phase-shift keying (BPSK), quadrature phase-shift keying (QPSK), M-phase-shift keying (M-PSK), M-quadrature amplitude modulation (M-QAM), among other examples of potential modulations for a waveform. As an example of a signal type, the type may be cyclic prefix orthogonal frequency division multiplexing (OFDM) (CP-OFDM) or discrete Fourier transform (DFT) spread OFDM (DFT-s-OFDM), among other examples of a signal type for a waveform. The A-MPR region may be based on a defined A-MPR, such as in a defined A-MPR table, or may be based on UE specific A-MPR information. In some aspects, the targeted use of repetition may be referred to as allocation based repetition. The use of repetition based on a frequency allocation enables a more efficient use of wireless resources by reducing the use of repetition resources outside of the A-MPR region of the frequency resources while maintaining the accuracy of communication of UEs with the NTN through the use of repetitions within the A-MPR region of the frequency resources for the waveform. This can enable the use of an expanded set of frequency resources by a wireless network, such as an NTN.

Additionally, or alternatively, in some aspects, the scheduling of resources relative to an A-MPR region for a waveform may be based on a power class of the UE for that waveform. As an example, a power class 2 (PC2) UE or a power class 1.5 (PC1.5) UE may allow higher transmission powers, such as a 26 dBm for PC2 and 29 dBm for PC 1.5 maximum output power). Such UEs may be referred to as a high power UE (HPUE). The UEs may still be subject to A-MPR, and in some cases, the A-MPR may scale 1:1 with the output power. However, there may be a subset of waveforms (e.g., one or more of a larger set of possible waveforms) where the HPUE can transmit at higher power (e.g., at least 23 dBm) compared to a power class 3 (PC3) UE that may have a maximum output power of 23 dBm before A-MPR. A UE may indicate, to the network, its support for a higher power class for a subset of waveforms. The network may use the UE information to schedule UEs that support the higher power class in frequency resources in an A-MPR region for the waveform in order to reserve non-A-MPR resources for UEs that do not support increased transmission powers. By saving the non-A-MPR resources for UEs with a lower power class, the network is able to more efficiently schedule frequency resources. The aspects presented herein enable communication over larger bandwidths and/or with higher data rates.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

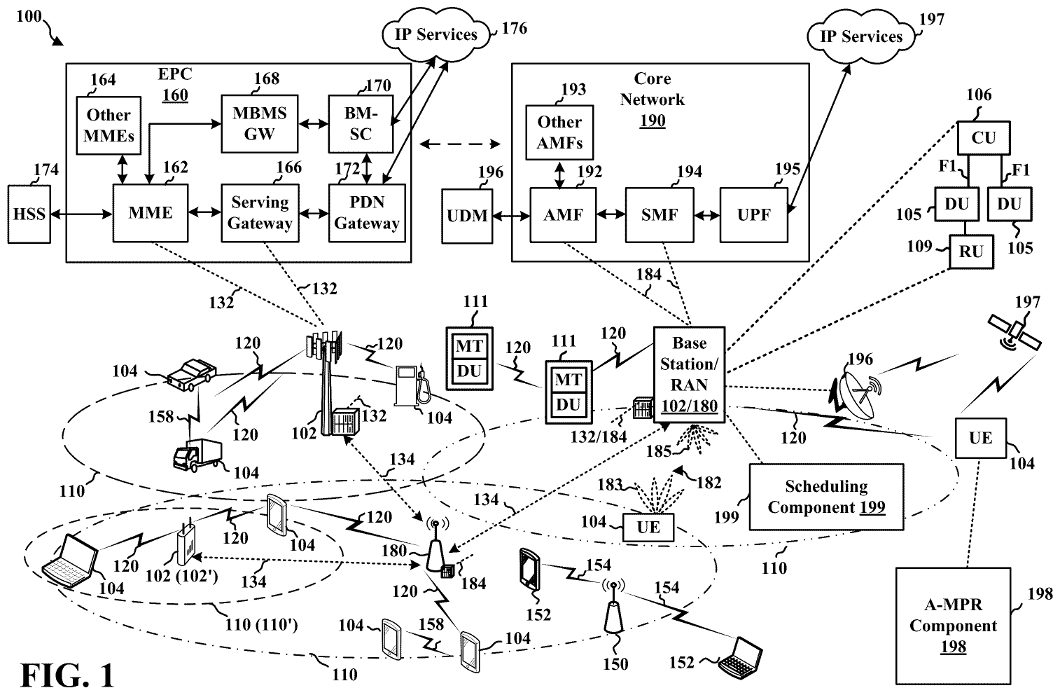

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHz, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 185. The UEs 104 may receive the beamformed signal from the base stations 180 in one or more receive directions 183. The UEs 104 may also transmit a beamformed signal to the base stations 180 in one or more transmit directions (e.g., 183). The base stations 180 may receive the beamformed signal from the UEs 104 in one or more receive directions (e.g., 185). The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the UE 104 may include an A-MPR component 198 configured to transmit, to a network node, additional maximum power reduction (A-MPR) information associated with the UE for one or more waveforms; and communicate with the network node based on the A-MPR information associated with the UE. In some aspects, the A-MPR component 198 may be configured to transmit, to a network node, an indication of support for an increased power class for a subset of waveforms; and receive, from the network node, scheduling information for a waveform in the subset of waveforms, the scheduling information indicating frequency resources in an A-MPR region of the waveform based on the support for the increased power class.

In some aspects, the base station 102 may include a scheduling component 199 configured to obtain A-MPR information associated with a UE for one or more waveforms; and schedule communication from the UE based on the A-MPR information associated with the UE. In some aspects, the scheduling component 199 may be configured to obtain an indication of support of a UE for an increased power class for a subset of waveforms; and schedule, based on the support for the increased power class, communication from the UE in frequency resources in an A-MPR region of the frequency resources for a waveform. In some aspects, the scheduling component 199 may be configured to schedule communication from a UE with repetition in an A-MPR region of frequency resources for a waveform; and obtain the communication with the repetition.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

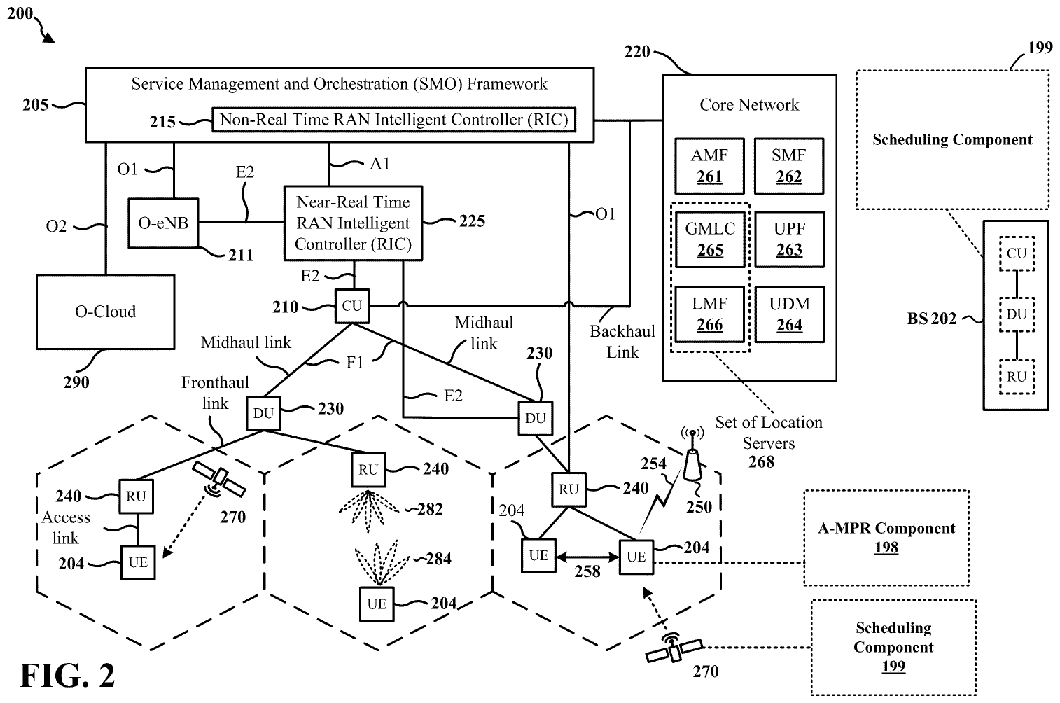

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUs (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position associated with the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, the UE 204, similar to the UE 104 in FIG. 1, may have an A-MPR component 198 that may be configured to transmit, to a network node, A-MPR information associated with the UE for one or more waveforms; and communicate with the network node based on the A-MPR information associated with the UE. In some aspects, the A-MPR component 198 may be configured to transmit, to a network node, an indication of support for an increased power class for a subset of waveforms; and receive, from the network node, scheduling information for a waveform in the subset of waveforms, the scheduling information indicating frequency resources in an A-MPR region of the waveform based on the support for the increased power class.

In some aspects, the base station 102, or one or more of the CU 210, the DU 230, or the RU 240, may include a scheduling component 199 configured to obtain A-MPR information associated with a UE for one or more waveforms; and schedule communication from the UE based on the A-MPR information associated with the UE. In some aspects, the scheduling component 199 may be configured to obtain an indication of support of a UE for an increased power class for a subset of waveforms; and schedule, based on the support for the increased power class, communication from the UE in frequency resources in an A-MPR region of the frequency resources for a waveform. In some aspects, the scheduling component 199 may be configured to schedule communication from a UE with repetition in an A-MPR region of frequency resources for a waveform; and obtain the communication with the repetition.

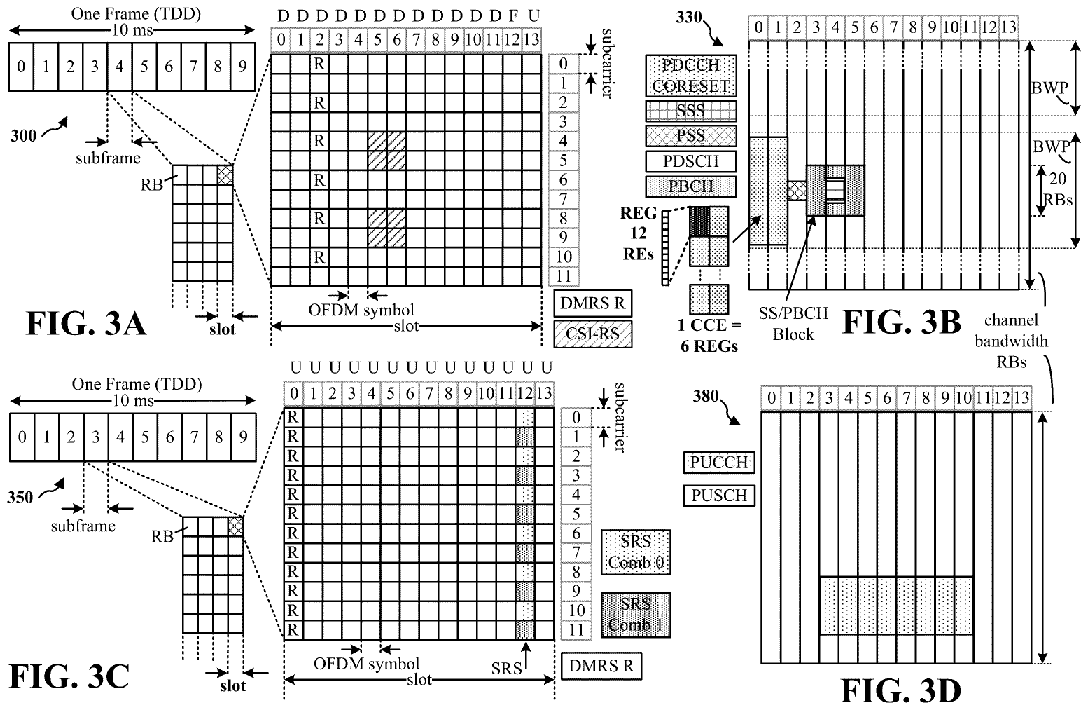

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. As shown in Table 1, the subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

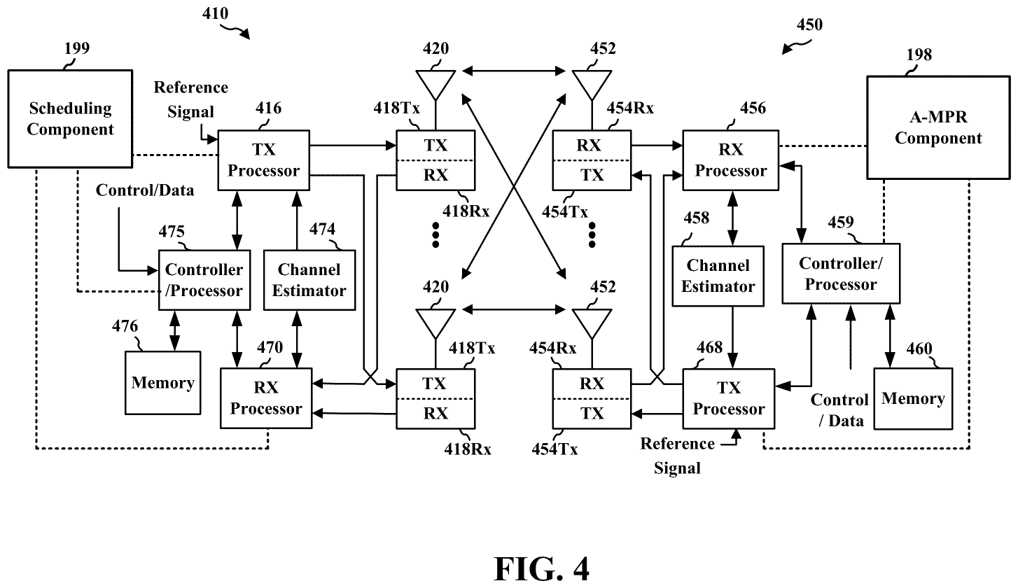

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the A-MPR component 198 of FIG. 1.

At least one of the TX processor 416, the RX processor 470, and the controller/processor 475 may be configured to perform aspects in connection with the scheduling component 199 of FIG. 1.

A non-terrestrial network (NTN) may refer to a wireless communication system that utilizes satellites in order to provide wireless communication services to UEs. In an example, a UE may transmit first data and/or first signal(s) to a satellite via a service link and the satellite may relay the first data and/or the first signal(s) to a network node (e.g., a base station) via a feeder link. In another example, the network node may transmit second data and/or second signal(s) to the satellite via the feeder link and the satellite may relay the second data and/or the second signal(s) to the UE via the service link.

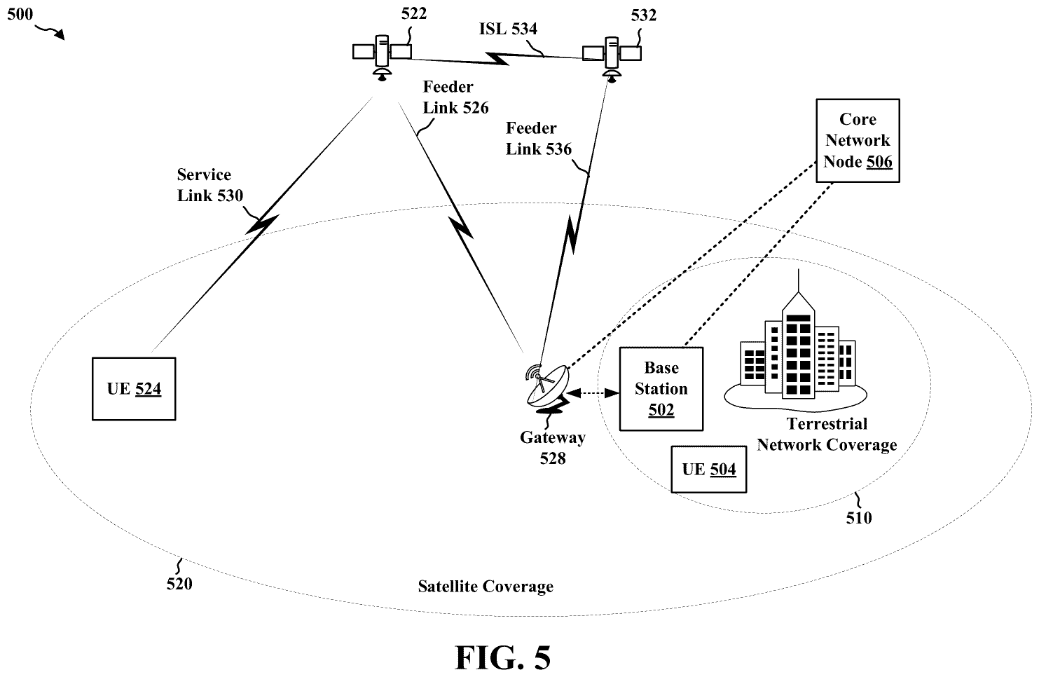

FIG. 5 is a diagram illustrating an example system 500 that may support wireless communication via a terrestrial network and an NTN, as presented herein. In the illustrated example of FIG. 5, the terrestrial network includes a base station 502 that provides coverage to UEs, such as an example UE 504, located within a coverage area 510 for the terrestrial network. The base station 502 may facilitate communication between the UE 504 and a core network node 506. Aspects of the core network node 506 may be implemented by a core network, such as the example core network 190 of FIG. 1 and/or the core network 220 of FIG. 2.

In some examples, a UE may transmit and/or receive satellite-based communication (e.g., via an Iridium-like satellite communication system or a satellite-based 3GPP NTN). The NTN node may be referred to by various names, such as an aerial device 522, a space vehicle (SV), or a satellite. In some examples, the aerial device 522 and/or the second aerial device 532 may include an aerial device, such as an unmanned aircraft system (UAS), a balloon, a drone, an unmanned aerial vehicle (UAV), etc. Examples of a UAS platform that may be used for NTN communication include systems including Tethered UAS (TUA), Lighter Than Air UAS (LTA), Heavier Than Air UAS (HTA), and High Altitude Platforms (HAPs). In some examples, the aerial device 522 and/or the second aerial device 532 may include a satellite or a space-borne vehicle placed into Low-Earth Orbit (LEO), Medium-Earth Orbit (MEO), Geostationary Earth Orbit (GEO), or High Elliptical Orbit (HEO).

The NTN node may provide coverage to UEs, such as an example UE 524, located within a coverage area 520 for the aerial device 522. In some examples, the aerial device 522 may communicate with the core network node 506 through a feeder link 526 established between the aerial device 522 and a gateway 528 in order to provide service to the UE 524 within the coverage area 520 of the aerial device 522 via a service link 530. The feeder link 526 may include a wireless link between the aerial device 522 and the gateway 528. The service link 530 may include a wireless link between the aerial device 522 and the UE 524. In some examples, the gateway 528 may communicate directly with the core network node 506. In some examples, the gateway 528 may communicate with the core network node 506 via the base station 502.

In some aspects, the aerial device 522 may be configured to communicate directly with the gateway 528 via the feeder link 526. The feeder link 526 may include a radio link that provides wireless communication between the aerial device 522 and the gateway 528. In other aspects, the aerial device 522 may communicate with the gateway 528 via one or more other aerial devices. For example, the aerial device 522 and a second aerial device 532 may be part of a constellation of satellites (e.g., aerial devices) that communicate via inter-satellite links (ISLs). In the example of FIG. 5, the aerial device 522 may establish an ISL 534 with the second aerial device 532. The ISL 534 may be a radio interface or an optical interface and operate in the RF frequency or optical bands, respectively. The second aerial device 532 may communicate with the gateway 528 via a second feeder link 536.

In some aspects, the aerial device 522 and/or the second aerial device 532 may implement a transparent payload. For example, after receiving a signal, a transparent aerial device may have the ability to change the frequency carrier of the signal, perform RF filtering on the signal, and amplify the signal before outputting the signal. In such aspects, the signal output by the transparent aerial device may be a repeated signal in which the waveform of the output signal is unchanged relative to the received signal.

In other aspects, the aerial device 522 and/or the second aerial device 532 may implement a regenerative payload. For example, a regenerative aerial device may have the ability to perform all of or part of the base station functions, such as transforming and amplifying a received signal via on-board processing before outputting a signal. In some such aspects, transformation of the received signal may refer to digital processing that may include demodulation, decoding, switching and/or routing, re-encoding, re-modulation, and/or filtering of the received signal.

In examples in which the aerial device implements a transparent payload, the transparent aerial device may communicate with the base station 502 via the gateway 528. In some such examples, the base station 502 may facilitate communication between the gateway 528 and the core network node 506. In examples in which the aerial device implements a regenerative payload, the regenerative aerial device may have an on-board base station.

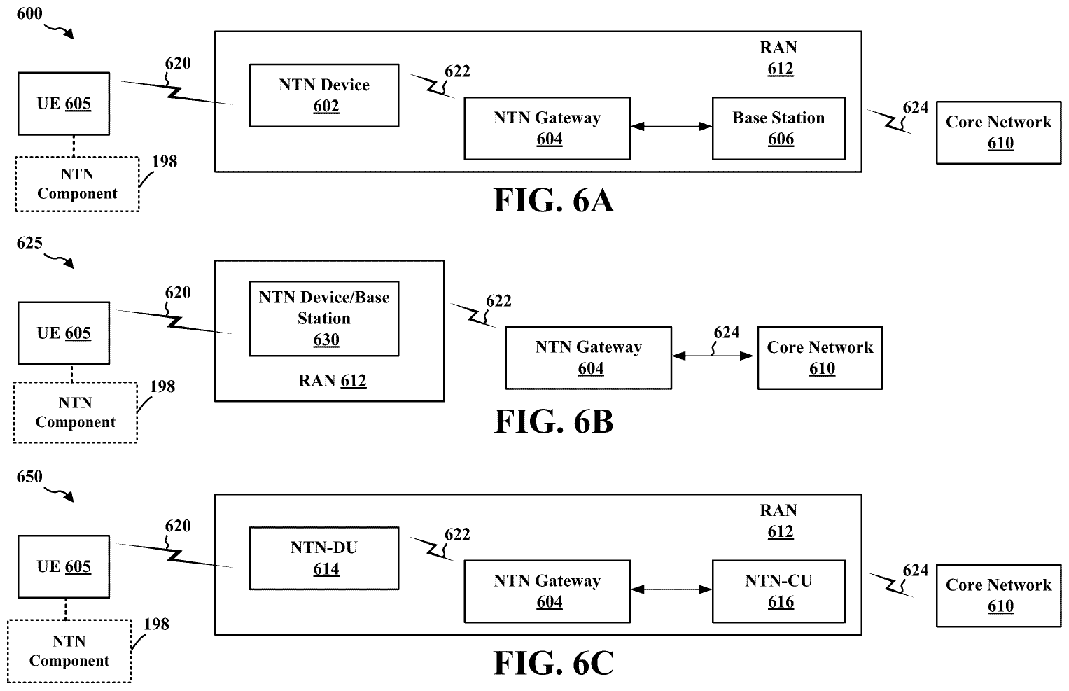

FIGS. 6A-6C illustrate example aspects of various network architecture examples capable of supporting NTN access. FIG. 6A illustrates a network architecture with transparent payloads. The network architecture 600 of FIG. 6A includes a UE 605, an NTN device 602 (which may also be referred to as a satellite, an aerial device, or a space vehicle, among other examples), an NTN gateway 604 (sometimes referred to as “gateway,” “earth station,” or “ground station”), and a base station 606 (which may also be referred to as a network node or network entity) having the capability to communicate with the UE 605 via the NTN device 602. The base station 606 may be a network node or network entity of a terrestrial communication network, for example. A network node may include a base station in aggregation or may correspond to one or more disaggregated components of a base station, such as a CU, DU, and/or RU. The NTN device 602, the NTN gateway 604, and the base station 606 may be part of a RAN 612. As one example, the NTN device 602, the base station 606, and the NTN gateway 604 may be part of an NG RAN, or a RAN for other communication technologies, such as 3G, 4G LTE, 6G, etc. The network architecture 600 is illustrated as further including a core network 610, which may correspond to the core network 190 described in connection with FIG. 1 and/or 220 in FIG. 2. A core network 610 may be a public land mobile network (PLMN), for example. Connections in the network architecture 600 with transparent payloads illustrated in FIG. 6A, allow the base station 606 to access the NTN gateway 604 and the core network 610. In some examples, the base station 606 may be shared by multiple PLMNs. Similarly, the NTN gateway 604 may be shared by more than one base station. Although the examples of FIG. 6A, FIG. 6B, and FIG. 6C illustrate one UE 605, many UEs may utilize the network architecture 600. Similarly, the network architecture 600 may include a larger (or smaller) number of NTN devices, NTN gateways, base stations, RAN, core networks, and/or other components. The illustrated connections that connect the various components in the network architecture 600 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 605 may be configured to communicate with the core network 610 via the NTN device 602, the NTN gateway 604, and the base station 606. As illustrated by the RAN 612, one or more RANs associated with the core network 610 may include one or more base stations. Access to the network may be provided to the UE 605 via wireless communication between the UE 605 and the base station 606 (e.g., a serving base station), via the NTN device 602 and the NTN gateway 604.

The base station 606 may be referred to by other names such as a network node, a network entity, a gNB, a “satellite node”, a satellite NodeB (sNB), “satellite access node”, etc. The base station 606 in FIG. 6A may be different than a terrestrial network base station, in some aspects, such as supporting additional capability beyond that of a terrestrial base station. For example, the base station 606 may terminate the radio interface and associated radio interface protocols to the UE 605 and may transmit DL signals to the UE 605 and receive UL signals from the UE 605 via the NTN device 602 and the NTN gateway 604. The base station 606 may also support signaling connections and voice and data bearers to the UE 605 and may support handover of the UE 605 between different radio cells for the NTN device 602, between different NTN devices and/or between different base stations. The base station 606 may be configured to manage moving radio beams (e.g., for airborne vehicles and/or non-geostationary (non-GEO) devices) and associated mobility of the UE 605. The base station 606 may assist in the handover (or transfer) of the NTN device 602 between different NTN gateways or different base stations. Additionally, a coverage area of the base station 606 may be much larger than the coverage area of a terrestrial network base station. In some examples, the base station 606 may be separate from the NTN gateway 604, e.g., as illustrated in the example of FIG. 6A. In other examples, the base station 606 may include or may be combined with one or more NTN gateways, e.g., using a split architecture. For example, with a split architecture, the base station 606 may include a CU, such as the example CU 106 in FIG. 1 or the CU 210 of FIG. 2, and the NTN gateway 604 may include or act as (DU, such as the example DU 105 in FIG. 1 or the DU 230 of FIG. 2). The base station 606 may be fixed on the ground for transparent payload operation. In one implementation, the base station 606 may be physically combined with, or physically connected to, the NTN gateway 604 to reduce complexity and cost.

The NTN gateway 604 may be shared by more than one base station and may communicate with the UE 605 via the NTN device 602. The NTN gateway 604 may be dedicated to one associated constellation of NTN devices. The NTN gateway 604 may be included within the base station 606, e.g., as a base station-DU within the base station 606.

In the illustrated example of FIG. 6A, a service link 620 may facilitate communication between the UE 605 and the NTN device 602, a feeder link 622 may facilitate communication between the NTN device 602 and the NTN gateway 604, and an interface 624 may facilitate communication between the base station 606 and the core network 610. The service link 620 and the feeder link 622 may be implemented by a same radio interface (e.g., a Uu interface).

FIG. 6B shows a diagram of a network architecture 625 capable of supporting NTN access similar to FIG. 6A, but having a network architecture for regenerative payloads, as opposed to transparent payloads shown in FIG. 6A. A regenerative payload, unlike a transparent payload, includes an on-board base station (e.g., includes the functional capability of a base station), and is referred to herein as an NTN device/base station 630. The on-board base station may be a network node that corresponds to the network device (e.g., 410 in FIG. 4, 102 in FIG. 1, or 202 in FIG. 2). The RAN 612 is illustrated as including the NTN device/base station 630 for communication with the UE 605 and the core network 610.

An on-board base station may perform many of the same functions as the base station 606, as described previously. For example, the NTN device/base station 630 may terminate the radio interface and associated radio interface protocols to the UE 605 and may transmit DL signals to the UE 605 and receive UL signals from the UE 605, which may include encoding and modulation of transmitted signals and demodulation and decoding of received signals. The NTN device/base station 630 may communicate with one or more NTN gateways and with one or more core networks via the NTN gateway 604. In some aspects, the NTN device/base station 630 may communicate directly with other NTN device/base stations using Inter-Satellite Links (ISLs), which may support an Xn interface between any pair of NTN device/base stations.

With low Earth orbit (LEO) devices, the NTN device/base station 630 may manage moving radio cells with coverage at different times. The NTN gateway 604 may be connected directly to the core network 610, as illustrated. The NTN gateway 604 may be shared by multiple core networks, for example, if NTN gateways are limited. In some examples the core network 610 may be aware of coverage area(s) of the NTN device/base station 630 in order to page the UE 605 and to manage handover.

FIG. 6C shows a diagram of a network architecture 650 similar to that shown in FIGS. 6A and 6B, that supports regenerative payloads, as opposed to transparent payloads, as shown in FIG. 6A, and with a split architecture for the base station. For example, the base station may be split between a CU (e.g., such as CU 106 of FIG. 1 or 210 of FIG. 2), and a DU (e.g., such as the DU 105 of FIG. 1 or the DU 230 of FIG. 2). In the illustrated example of FIG. 6C, the network architecture 650 includes an NTN-CU 616, which may be a component of a ground-based base station or a terrestrial base station. The regenerative payloads include an on-board base station DU, and is referred to herein as an NTN-DU 614. The NTN-CU 616 and the NTN-DU 614, collectively or individually, may correspond to the network node associated with the network device (e.g., base station 410) in FIG. 4.

The NTN-DU 614 communicates with the NTN-CU 616 via the NTN gateway 604. The NTN-CU 616 together with the NTN-DU 614 perform functions, and may use internal communication protocols, e.g., based on a split architecture. The NTN-CU 616 and the NTN-DU 614 may each support additional capabilities to provide the UE 605 access using NTN devices.

The NTN-DU 614 and the NTN-CU 616 may communicate with one another using an F1 Application Protocol (F1AP), and together may perform some or all of the same functions as the base station 606 or the NTN device/base station 630 as described in connection with FIGS. 6B and 6C, respectively.

The NTN-DU 614 may terminate the radio interface and associated lower level radio interface protocols to the UE 605 and may transmit DL signals to the UE 605 and receive UL signals from the UE 605, which may include encoding and modulation of transmitted signals and demodulation and decoding of received signals. The operation of the NTN-DU 614 may be partly controlled by the NTN-CU 616. The NTN-DU 614 may support one or more radio cells for the UE 605. The NTN-CU 616 may also be split into separate control plane (CP) (NTN-CU-CP) and user plane (UP) (NTN-CU-UP) portions. The NTN-DU 614 and the NTN-CU 616 may communicate over an F1 interface to (a) support control plane signaling for the UE 605 using IP, Stream Control Transmission Protocol (SCTP) and F1 Application Protocol (F1AP) protocols, and (b) to support user plane data transfer for a UE 605 using IP, User Datagram Protocol (UDP), PDCP, SDAP, GTP-U and NR User Plane Protocol (NRUPP) protocols.

The NTN-CU 616 may communicate with one or more other NTN-CUs and/or with one more other terrestrial base stations using terrestrial links to support an Xn interface between any pair of NTN-CUs and/or between the NTN-CU 616 and a terrestrial base station.

Some NTN communication may be based on low rate, infrequent communications for short messaging and/or emergency use when a UE is outside of terrestrial network coverage. Aspects presented herein provide solutions that enable larger economies of scale, compatibility, cost reduction, and more seamless terrestrial cellular network integration for NTNs. Aspects presented herein can also help to enable communication over larger bandwidths and/or with higher data rates, such as to enable broadband service via an NTN.

A link budget provides an accounting of power gains and losses that a communication signal experiences based on a transmission power, and the link budget can be used to calculate an anticipated received signal at a receiver. The link budget is affected by propagation path loss and bandwidth, among other factors. An NTN link budget, such as for an uplink signal from a terrestrial UE to a satellite, can be challenging due to the limited transmission power available from the UE and the large propagation distance to the satellite.

An example path loss term for a device transmitting communication from Earth to a geosynchronous satellite (e.g., at an altitude of 37,786 km) at an S-band (e.g., ˜2 GHz, λ≈0.15 m) is −190 dB, which can be a significant path loss to address. Example UE transmit powers are PC3 corresponding to 23 dBm or PC2 corresponding to 26 dBm.

One technique to meet the uplink link budget is to use narrowband allocations so that the UE uplink power can be concentrated into narrow bandwidth. Narrowband allocations support low data rate communications, but may not support higher data rates. Repetitions of transmissions may help to improve the link budget, but the reception of repetitions consume additional network resources (e.g., satellite resources) and additional power at the UE.

An increased transmission power from the UE can improve the link budget. In some aspects, the available UE transmit power may be limited based on emissions requirements, which may also be referred to as emission limits. As an example, the UE may transmit wireless communications that meet various emissions requirements that apply to all frequency bands, such as requirements for adjacent channel leakage ratio (ACLR), spectrum emission mask (SEM), spurious emissions, etc. As the emissions requirements apply to all frequency bands, they requirements may be referred to as general requirements. As an example, spurious emissions may be caused by unwanted transmission effects. In order to meet the emissions requirements, the UE may employ a maximum power reduction (MPR) power backoff to reduce a transmission power at the UE. For example, the UE may reduce the maximum transmission power by an amount indicated for MPR.

Some frequency bands may have additional emission requirements beyond the general requirements. An additional power backoff may be allowed and may be referred to as additional maximum power reduction (A-MPR). As an example, in the LS band (e.g., 1610-1626.5 MHz UL), there may be protection for frequencies below the band to protect nearby GNSS operation. The LS band is merely an example to illustrate the concept, and the aspects may be similarly applicable for other frequency bands. The UL may further reduce the maximum transmission power used by the UL based on the A-MPR, and the A-MPR may be specific to particular frequency resources.

MPR and A-MPR may reduce the available transmit power for a PC3 UL below a maximum PC3 23 dBm power level. For example, an A-MPR of 3 dB could correspond to a maximum available transmission power for that waveform of 20 dBm (e.g., rather than the maximum 23 dBm power for PC3).

Tables 2-3 illustrate various examples of emissions requirements, which lead to a reduction in transmission power that is used by a UL. As described above, the UL may meet the emissions requirements by backing off (e.g., reducing) transmission power. As a first example, table 2 illustrates an example of additional out-of-band emission requirements based on ETSI regulations. As another example, table 3 illustrates an example of Federal Communications Commission (FCC).

### Additional Out-of-Band Emission Requirements Based on ETSI Regulations.

TABLE 2

| | Channel | | | |
|---|---|---|---|---|
| | bandwidth / | | | |
| | Spectrum emission | | | |
| | limit¹ (dBm) | | | |
| Frequency band | 5 MHz, 10 MHz, | Measurement | | |
| (MHz) | 15 MHz | bandwidth | | NOTE |
| 1559 ≤ f ≤ 1605 | −40 | 1 | MHz | Averaged over any |
| | | | | 2 millisecond |
| 1605 ≤ f ≤ 1610 | −40 + 60/5 | 1 | MHz | active transmission |
| | (f-1605) | | | interval |
| 1628.5 ≤ f ≤ 1631.5 | −30 | 30 | kHz | |
| 1631.5 ≤ f ≤ 1636.5 | −30 | 100 | kHz | |
| 1636.5 ≤ f ≤ 1646.5 | −30 | 300 | kHz | |
| 1646.5 ≤ f ≤ 1666.5 | −30 | 1 | MHz | |
| 1666.5 ≤ f ≤ 2200 | −30 | 3 | MHz | |

NOTE:
The EIRP requirement in regulation may be converted to conducted requirement using a 0 dBi antenna.

### Table 6.5.3.3.3-1: Additional Out-of-Band Requirements for “NS_03N”

TABLE 3

| | Channel | | | |
|---|---|---|---|---|
| | bandwidth / | | | |
| | Spectrum | | | |
| | emission | | | |
| | limit¹ (dBm) | | | |
| Frequency | 5 MHz, | | | |
| band | 10 MHz, | Measurement | | |
| (MHz) | 15 MHz | bandwidth | | NOTE |
| 1559 ≤ f ≤ 1605 | −50 | 700 | Hz | Discreet emissions |
| 1605 ≤ f ≤ 1610 | −50 + 60/5 | 700 | Hz | averaged over any |
| | (f-1605) | | | 2 millisecond |
| | | | | active transmission |
| | | | | interval |
| 1559 ≤ f ≤ 1605 | −40 | 1 | MHz | Averaged over |
| | | | | any 2 millisecond |
| 1605 ≤ f ≤ 1610 | −40 + 60/5 | 1 | MHz | active transmission |

| | |
|---|---|
| (f-1605) | interval |

NOTE:
The EIRP requirement in regulation may be converted to conducted requirement using a 0 dBi antenna.

Table 4 illustrates various examples of NTN satellite operating bands. As an example, an LS band may be used for NR NTN. The LS band may correspond to n254 in Table 4, for example. The frequency bands are merely examples, and the aspects presented herein may also be applied for other frequency bands.

### Table 5.2.2-1: NTN Satellite Bands in FR1

TABLE 4

| | Uplink (UL) | Downlink (DL) | |
|---|---|---|---|
| NTN | operating band | operating band | |
| satellite | Satellite Access Node | Satellite Access Node | |
| operating | receive / UE transmit | transmit / UE receive | Duplex |
| band | F_{UL, low}-F_{UL, high} | F_{DL, low}-F_{DL, high} | mode |
| n256 | 1980 MHz-2010 MHz | 2170 MHz-2200 MHz | FDD |
| n255 | 1626.5 MHz-1660.5 MHz | 1525 MHz-1559 MHz | FDD |
| n254 | 1610-1626.5 MHz | 2483.5-2500 MHz | FDD |

NOTE:
NTN satellite bands are numbered in descending order from n256.

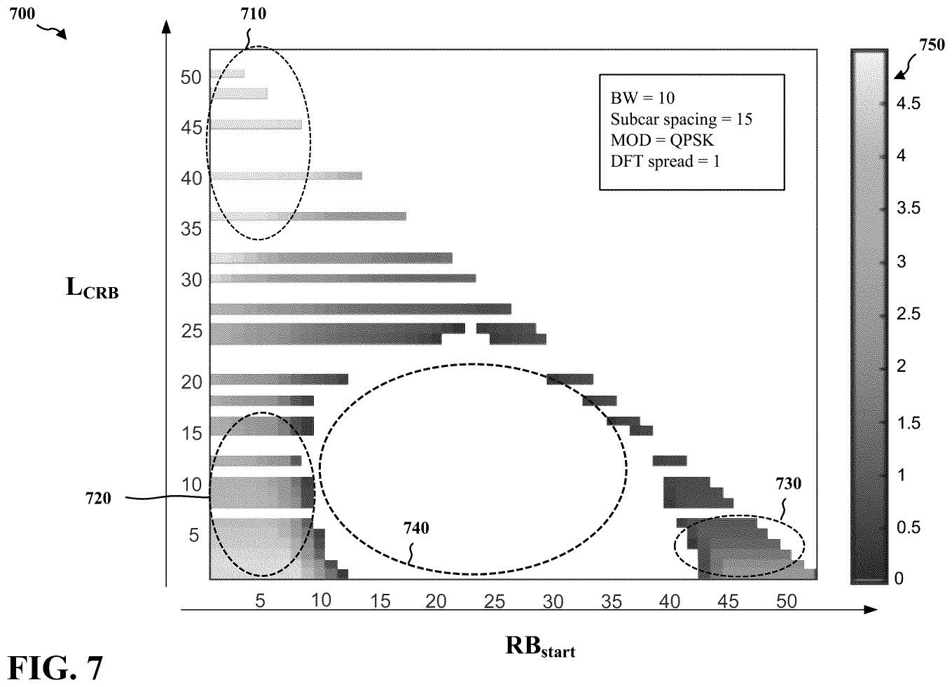

FIG. 7 illustrates an example graph 700 showing frequency resources for a 10 MHz channel at 1615 MHz affected by A-MPR for an example QPSK, DFT-S-OFDM waveform associated with a 23 dBm for power control. The frequency resources may be referred to as including an A-MPR region and non-A-MPR region. The “A-MPR region” refers to the subset of frequency resources that include A-MPR. The “non-A-MPR region” refers to the subset of frequency resources that do not include A-MPR. The horizontal axis corresponds to a starting RB of a frequency allocation, e.g., which may be referred to as RBₛₜₐᵣₜ or as a startling location of the allocation. The starting RB indicates a starting location in a frequency domain for RBs allocated for an uplink transmission from the UE. The vertical axis represents a length of the resource allocation (e.g., which may be referred to as L_{CRB} or the number of contiguous RB). A frequency domain position for an uplink resource allocation can be indicated by the starting RB and the number of contiguous RBs from the starting RB that are allocated to the UE for the uplink transmission. Frequency resource allocations at 710 have wider allocations (e.g., having a higher L_{CRB}). Frequency resource allocations illustrated at 720 and 730 have narrower frequency allocations (e.g., smaller L_{CRB}). Frequency resource allocations 720 are closer to a lower edge of the channel, e.g., nearer to a channel boundary.

The shading gradient 750 illustrates the amount of power backoff (A-MPR) to meet emission requirements for the corresponding frequency allocations. In the example, up to 5 dB power backoff can be used for A-MPR. Wideband waveforms having a larger frequency allocation, e.g., a higher L_{CRB} as shown at 710, can be more affected by the power backoff, e.g., may have a higher power backoff range. As well, narrowband waveforms at a lower edge of the channel (e.g., as shown at 720 and 730) may also have a power backoff based on the location to closer to the channel edge. Waveforms with frequency resources closer to the channel edge may be referred to as “outer waveforms,” and waveforms with frequency resources further from the channel edge may be referred to as “inner waveforms.” The inner waveforms (e.g., based on frequency allocations in the middle of the channel with a moderate length) are illustrated in FIG. 7 as being without a power backoff based on A-MPR. The region 740 may be referred to as a non-A-MPR region because the resources in that region are not subject to A-MPR, and the other regions (e.g., including resources shown at 710, 720, and 730) may be referred to as A-MPR regions because the resources in that region are subject to A-MPR.

For uplink link budgets, such as an NTN link budget that involves large distances of propagation delay, additional power back off can reduce achievable data rates. The non-A-MPR waveforms, e.g., in the non-A-MPR region 740 can be useful for wireless communication with link budget limitations, such as NTN communication. The non-A-MPR waveforms may be referred to by other names, such as “inner waveforms,” “allocations in the center of the channel of low to moderate length,” etc. Other waveforms, e.g., such as at the channel edge, may not be used. In some aspects, the other waveforms that are not used may be considered a guard band.

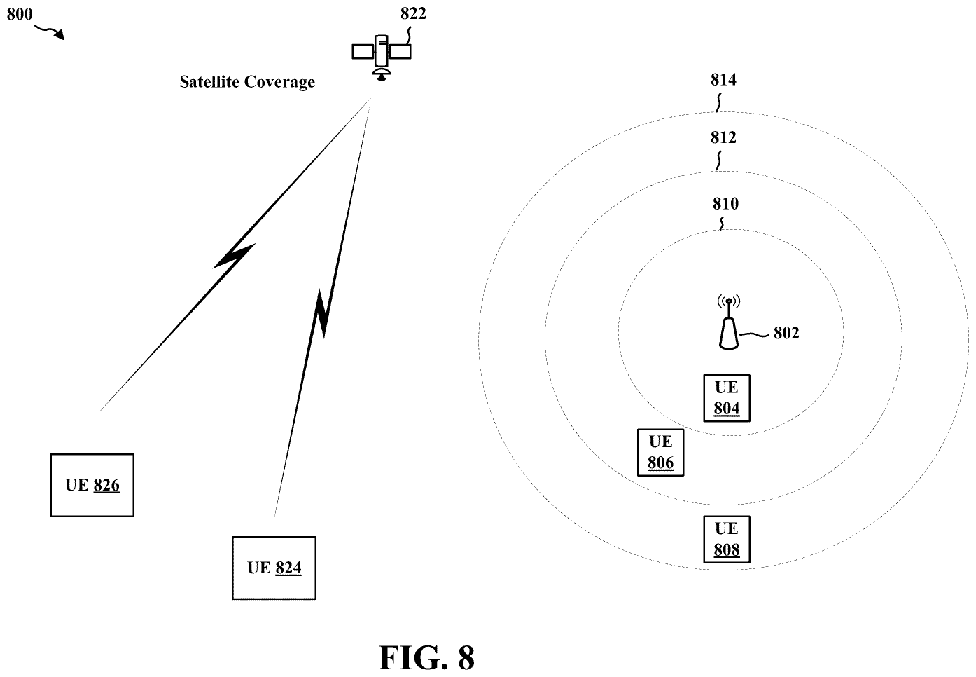

In a terrestrial network, power amplification may be optimized for power efficiency at the cost of linearity. A network (e.g., a base station or one or more components of a base station) may schedule frequency resources (e.g., RBs) differently for UEs in different schemes. The different schemes may be based on one or more of a cell center coverage, a mid-cell coverage, a cell-edge coverage, based on the location of the various UEs within the cell. FIG. 8 is a diagram 800 showing an example of a terrestrial base station 802 and example UEs in different cell coverage areas of the terrestrial base station, e.g., a UE 804 in center cell coverage region 810, a UE 806 in a mid-cell coverage region 812, and a UE 808 in a cell-edge coverage region 814. For example, the base station may schedule UEs (e.g., UE 804) that are nearer to the base station (e.g., in a cell center area/region) with frequency resources that correspond to a higher A-MPR. For example, the UE's closer to the cell edge can transmit with a higher power due to the allocation of resources without a reduction due to A-MPR, while the network is more likely to accurately receive communication from the UE's that are closer to the cell center even with a reduction in transmission power due to A-MPR. The base station may schedule UEs that are in a cell-edge area/region (e.g., UE 808) with resources that correspond to a lower or no A-MPR so that the uplink transmissions can be transmitted with a higher power and will be more likely to be accurately received by the base station even though the UE is near the cell-edge. As another example, the base station may schedule UEs (e.g., UE 806) in a mid-cell region with resources that correspond to a low A-MPR.

In some aspects, NTN resources may be more expensive to use than terrestrial network resources, and might be regarded as secondary or supplemental for occasional or emergency use by a UE that is out of coverage of a terrestrial network. Therefore, power consumption may not be as prioritized for such NTN use cases. As well, each of the UEs in the coverage NTN cell can be regarded as being at the cell edge, because each of the UEs are at a distance from the satellite or other aerial device. FIG. 8 also illustrates an example of a satellite 822 as part of an NTN that provides service to UEs 824 and 826. Due to the distance between the satellite and the surface of the Earth, each of the UEs may be considered to be located at or near a cell edge of the NTN. For the NTN, there is a large distance between each of the UEs and the satellite, and the NTN is not able to schedule some of UEs with RBs having a higher A-MPR based on the UE's having a location close to the satellite, because none of the UEs are close to the satellite. If the NTN schedules each UE with resources that do not have an A-MPR, or have a lower A-MPR, the resources available for scheduling are reduced. If the NTN schedules the UEs using a broader set of resources that includes resources having A-MPR, the transmissions from some UEs may not be accurately received at the satellite due to the transmission power reductions based on the A-MPR.

Aspects presented herein help to maintain the quality of service provided by the NTN while enabling increased efficiency in the use of scheduling resources. In order to reduce A-MPR, some aspects may trade power efficiency to gain linearity.

If the A-MPR free resources (e.g., A-MPR region or resources) can be extended, the NTN has more resources available to allocate to UEs. In some aspects, the network may use a defined A-MPR table that is specified in a wireless standard when determining frequency resource allocations for UEs. The A-MPR in the wireless standard may be given as a is less than or equal to threshold. The actual A-MPR can be smaller than or equal to the specified A-MPR, but cannot be larger, for example. As the defined table is to apply to various types of UEs, the A-MPR resources may be defined based on the UEs that are most affected by A-MPR. Other UEs may have an actual A-MPR that differs from the defined A-MPR in the wireless standard. The UE's actual A-MPR may be referred as a “UE specific A-MPR,” in contrast to the defined A-MPR that is applicable for multiple UEs. For example, the UE specific A-MPR may include an expanded set of non-A-MPR frequency resources (e.g., larger than a minimum set of frequency resources in the defined A-MPR table) for which the UE can be scheduled by the NTN. As an example, some UEs may be designed with an improved linearity for transmission power and/or a reduced A-MPR (e.g., a larger RB space where full power transmission is possible). As presented herein, the UE may signal the actual, or UE specific A-MPR information to the network, and the network may schedule the UE with frequency resources based on its actual A-MPR rather than a defined MPR. For example, the network may schedule the UE with frequency resources that are indicated as having A-MPR in the wireless standard and having no A-MPR in the information (e.g., actual A-MPR for the UE) reported by the UE to the network.

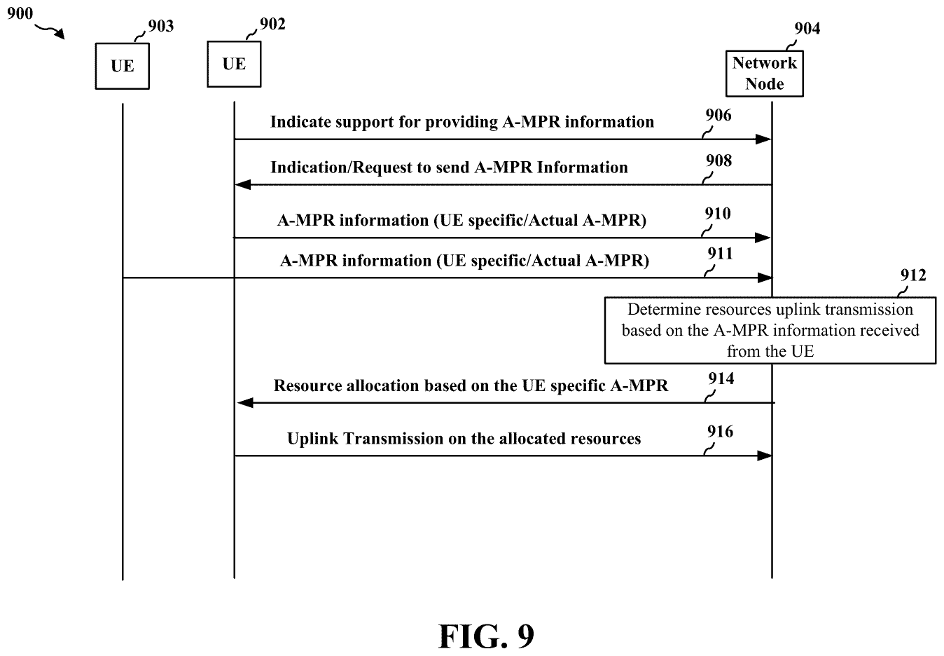

FIG. 9 illustrates an example communication flow 900 between a UE 902 and a network node 904. The network node may be an NTN node, in some aspects. As an example, the network node 904 may comprise or be a part of a geosynchronous satellite. In some aspects, the network node 904 may be a terrestrial network node. In some aspects, the network node may be a base station or one or more components of a base station and may include one or more of a CU, DU and/RU. Various aspects of the method may improve scheduling efficiency and/or reliability for uplink transmissions while meeting emissions requirements. In some aspects, the method may enable broader frequency band service to be provided to UEs, enabling an increased data rate and richer diversity of service.

As illustrated at 910, the UE 902 may transmit A-MPR information for the UE to the network node 904. The A-MPR information includes the UE's actual A-MPR, e.g., a UE specific A-MPR, in contrast to a defined A-MPR that is applicable to various UEs. The A-MPR information may be for a single waveform. In some aspects, the UE may provide the network node with A-MPR information for multiple waveforms. The UE specific A-MPR region may include an A-MPR region (e.g., a subset of frequency resources for which an A-MPR is applicable for the UE) and a non-A-MPR region (e.g., a subset of frequency resources for which there is no A-MPR for the UE). For example, the non-A-MPR region includes frequency resources for a waveform that the UE supports without a power backoff, e.g., without an A-MPR. For example, FIG. 8 illustrates an example non-A-MPR region at 740. At 912, the network node may determine resources to allocate (or grant) to the UE 902 for uplink transmissions based on the UE specific A-MPR information received from the UE at 910. The network node 904 may receive A-MPR information from multiple UEs (e.g., as shown for an additional UE 903 that sends its UE specific A-MPR information 911 for one or more waveforms to the network node), and may allocate frequency resources among the multiple UEs based on the different A-MPR information from the different UEs. For example, the network node 904 may allocate frequency resources within non-A-MPR regions of the corresponding UEs, in some aspects.

As illustrated at 914, the network node 904 transmits a frequency resource allocation to the UE 902 with a grant of resources, or scheduling of resources, based on the A-MPR information provided by the UE at 910. As an example, the UE 902 may receive an allocation of frequency resources that are within a non-A-MPR region indicated by the UE in the UE specific A-MPR information at 910. The frequency resources may be within a defined A-MPR region for the waveform, yet in the non-A-MPR region of the actual A-MPR for the UE, for example. In some aspects, the network node 904 may determine to allocate frequency resources for the UE that are within an A-MPR region for the UE with an adjustment to compensate for the A-MPR. For example, at 914, the network node 904 may allocate frequency resources for the UE 902 that are in the A-MPR region for the UE, and may indicate for the UE to transmit the uplink transmissions with repetition. The repetition can improve the reliability of the uplink transmissions, e.g., to compensate for the A-MPR.

In some aspects, the UE may further indicate support for an increased power class for a subset of waveforms (e.g., rather than for all waveforms). Based on the indication of support for the increased power class, the network node 904 may allocate frequency resources for the UE 902 that are in the A-MPR region for the UE, because the UE is able to transmit with a higher transmission power.

At 916, the UE 902 transmits the uplink transmission to the network node 904 based on the resources allocated at 914. By the UE 902 providing its actual A-MPR information to the network, the network is able to perform more efficient scheduling for UEs, e.g., by scheduling one or more UEs in the frequency resources of an expanded A-MPR region that the one or more UEs support compared to a defined A-MPR. Additionally, or alternatively, the network may increase scheduling efficiency by scheduling UEs for repetition based on the UE's particular A-MPR information (e.g., when frequency resources are allocated in an A-MPR region for the particular UE). For example, the network may more efficiently schedule resources by limiting repetition to UE's that are allocated frequency resources in an A-MPR region for the respective UE. UEs that are scheduled with frequency resources in a non-A-MPR region for the UE can be scheduled without repetition. By differentiating between the resources scheduling A-MPR and non-A-MPR regions of the respective UEs when scheduling repetitions, the network may more efficiently use wireless resources while improving communication in the A-MPR region. Additionally, or alternatively, by scheduling UEs that support a higher power class in an A-MPR region, the network node may be able to reserve resources in a non-A-MPR region for UEs that do not support the higher power class. The network node is able to more efficiently schedule the various UEs while maintaining reliable communication with the UEs.

In some aspects, the UE 902 may transmit an indication of support, at 906, for providing the UE specific A-MPR information. Based on the UE's support, in some aspects, the network node 904 may transmit an indication or a request, at 908, for the UE 902 to provide the UE specific A-MPR information. In response, the UE 902 may transmit the A-MPR information for the UE, at 910.

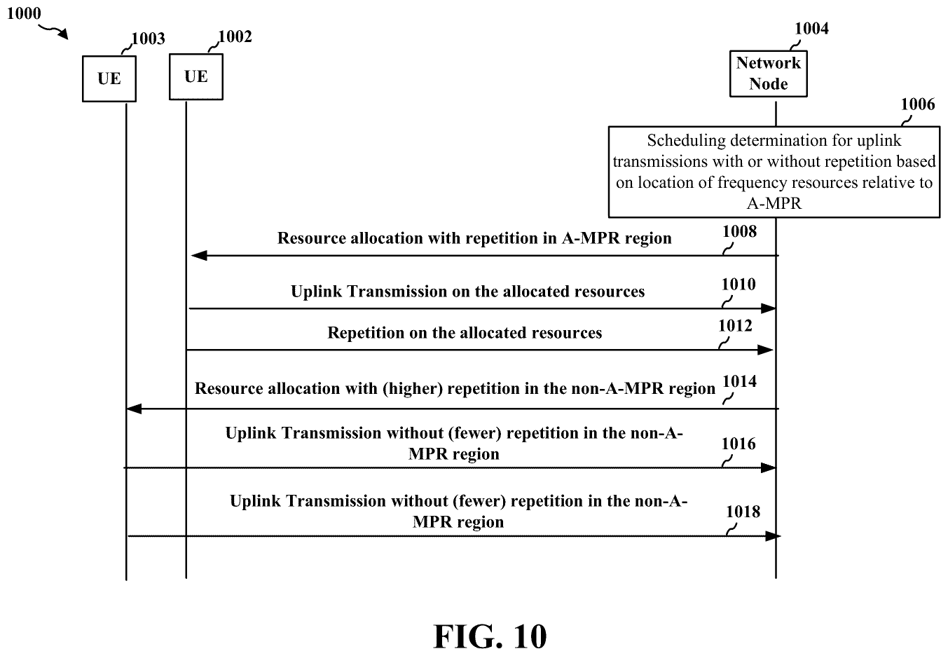

In some aspects, the network node may schedule repetitions of uplink transmissions that are targeted for UEs scheduled in frequency resources within an A-MPR region for a waveform. In some aspects, the targeted use of repetition may be referred to as allocation based repetition. FIG. 10 illustrates an example communication flow 1000 between a network node 1004 and UEs 1002 and 1003 that includes the allocation based repetition. In some aspects, the network node 1004 may be an NTN node. As an example, the network node 1004 may comprise or be a part of a geosynchronous satellite. In some aspects, the network node 1004 may be a terrestrial network node. In some aspects, the network node may be a base station or one or more components of a base station and may include one or more of a CU, DU and/RU. Various aspects of the method may improve scheduling efficiency and/or reliability for uplink transmissions while meeting emissions requirements. In some aspects, the method may enable more efficient use of wireless resources by reducing the use of repetition resources by targeting the use of repetition for UEs scheduled in an A-MPR region for a waveform.

As shown at 1006, the network node 1004 determines scheduling for one or more UEs (e.g., 1002 and 1003) for uplink transmissions based on a location of the allocated frequency resources relative to A-MPR resources.

At 1008, the network node 1004 transmits an indication of a resource allocation to the UE 1002. The network node 1004 allocations resources in an A-MPR region for the waveform, and schedules the UE for repetition based on the resources being in the A-MPR region for the waveform. The UE 1002 then transmits an uplink transmission 1010 using the allocated resources, and one or more repetition 1012 of the uplink transmission. The network node 1004 transmits an indication of a resource allocation to the UE 1003, granting resources in a non-A-MPR region for the waveform, and schedules the UE 1003 to transmit without repetition based on the resources being in the non-A-MPR region for the waveform. The UE 1003 then transmits an initial (or single) uplink transmission 1016 without repetition (or with fewer repetitions) based on the scheduling information that the UE 1003 receives at 1014. For example, a number of repetitions may be based on whether the frequency resources being within, or overlapping with an A-MPR region. In some aspects, the network node may schedule additional uplink communication (e.g., 1018) with fewer repetitions than the communication scheduled, at 1014, based on the uplink transmission 1018 being scheduled for frequency resources associated with a lower A-MPR than the frequency resources for the uplink transmission 1014. For example, an amount of repetition for the communication may be based on A-MPR information, e.g., whether the frequency resources overlap with an A-MPR region for a waveform, and/or the level of A-MPR associated with the frequency resources.

In some aspects, the A-MPR region used by the network node 1004 may be a UE specific A-MPR region, e.g., as described in connection with FIG. 9. In some aspects, the A-MPR region for the waveform may be based on a defined A-MPR table that is specified in a wireless standard. In some aspects, the network node 1004 may use UE specific A-MPR information, if it is provided by a UE, and may use the defined A-MPR table if the UE does not provide UE specific A-MPR information. The use of the A-MPR information enables the network node to schedule repetitions on a per UE basis, e.g., based on the frequency in which resources are allocated relative to A-MPR.

As frequency resources (e.g., RB's) with A-MPR may otherwise not be used, the targeted use of the resources along with repetitions to improve the link budget enables the network node to use a broader range of frequency resources to schedule UEs. Although the repetitions use more network resources and may have increased latency, the repetitions enable the use of the RB's that may otherwise not be used.

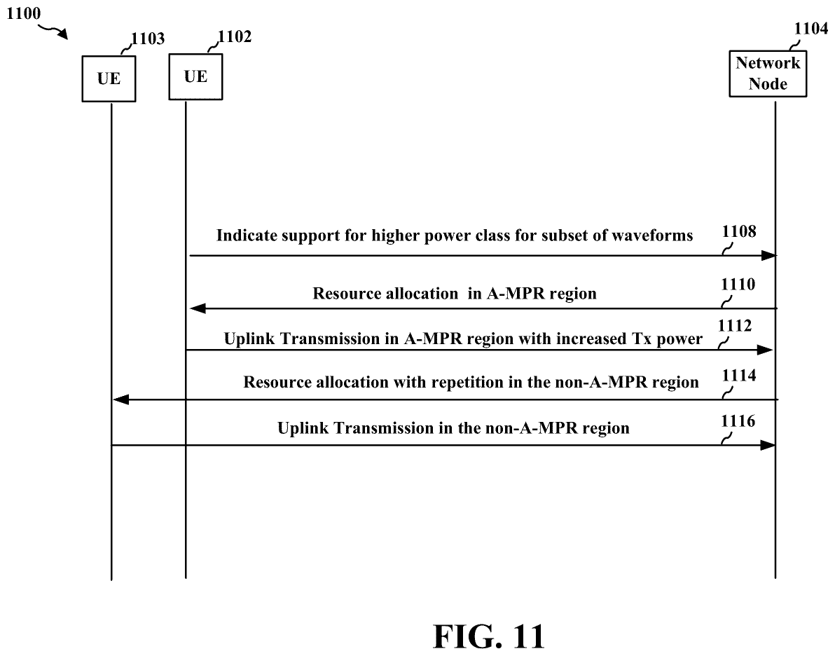

In some aspects, the scheduling of resources relative to an A-MPR region for a waveform may be based on a power class of the UE for that waveform. As an example, a power class 2 (PC2) UE or a power class 1.5 (PC1.5) UE may allow higher transmission powers, such as a 26 dBm for PC2 and 29 dBm for PC 1.5 maximum output power). Such UEs may be referred to as a high power UE (HPUE). The UEs may still be subject to A-MPR, and in some cases, the A-MPR may scale 1:1 with the output power. However, there may be a subset of waveforms (e.g., one or more of the waveform options) where the HPUE can transmit at higher power (e.g., at least 23 dBm) compared to a power class 3 (PC3) UE that may have a maximum output power of 23 dBm before A-MPR. FIG. 11 illustrates an example communication flow 1100 between a network node 1104 and UEs 1102 and 1103 that includes allocation based on power class information for particular waveforms. In some aspects, the network node 1104 may be an NTN node. As an example, the network node 1104 may comprise or be a part of a geosynchronous satellite. In some aspects, the network node 1104 may be a terrestrial network node. In some aspects, the network node may be a base station or one or more components of a base station and may include one or more of a CU, DU and/RU. Various aspects of the method may improve scheduling efficiency and/or reliability for uplink transmissions while meeting emissions requirements. In some aspects, the method may enable more efficient use of wireless resources by scheduling UEs that support higher power classes for a waveform to frequency resources in an A-MPR region for the waveform in order to reserve non-A-MPR resources for UEs that do not support increased transmission powers. By leaving the non-A-MPR resources for UEs, such as PC3 UEs, the network is able to more efficiently use the available resources. The UE can facilitate the network scheduling by signaling its power class for one or more waveforms to the network, e.g., in addition to or as an alternative to signaling A-MPR information as described in connection with FIG. 9.

As an example, FIG. 11 shows a UE 1102 that transmits an indication of support 1108 for a higher power class for a subset of waveforms to the network node 1104. For example, of a set of M waveforms, the UE may indicate that it supports the increased power class for N of the M waveforms, where N<M, in which N and M are both integers that are greater than one. For example, the indication of the power class may be specific to one or more waveforms. In some aspects, the UE may individually indicate the power class for individual waveforms. At 1110, the network node 1104 may schedule the UE 1102 with an allocation of resources for an uplink transmission in the A-MPR region of frequency resources for a waveform for which the UE 1102 indicated the increased power class. The UE 1102 transmits the uplink transmission 1112 using frequency resources in the A-MPR region for the waveform based on the allocated resources, at 1110. The UE may transmit the uplink transmission 1112 with an increased transmission power, e.g., based on the higher power class that the UE supports for the waveform.

The network node 1104 may allocate resources, at 1114, to a UE 1103 that does not support the higher power class for the waveform (or that does not indicate support for the higher power class for the waveform) in the non-A-MPR region of frequency resources for the waveform. At 1116, the UE 1103 may then transmit an uplink transmission using the frequency resources in the non-A-MPR region for the waveform based on the resource allocation received at 1114. The uplink transmission at 1116 may have a lower transmission power than the uplink transmission at 1112, e.g., based on the UE 1103 supporting a lower power class having a lower maximum output power for the waveform than the power class supported by the UE 1102 for the waveform.

FIG. 1200 is a flowchart 1200 of a method of wireless communication. The method may be performed by a UE (e.g., the UE 104, 204, 450, 504, 524, 605, 824, 826, 804, 806, 808, 902, 903, 1002, 1003, 1102, 1103; the apparatus 1704). The method may help to improve scheduling efficiency and/or reliability for uplink transmissions while meeting emissions requirements. The method helps to enable broader frequency band service to be provided to UEs, enabling an increased data rate and richer diversity of service.

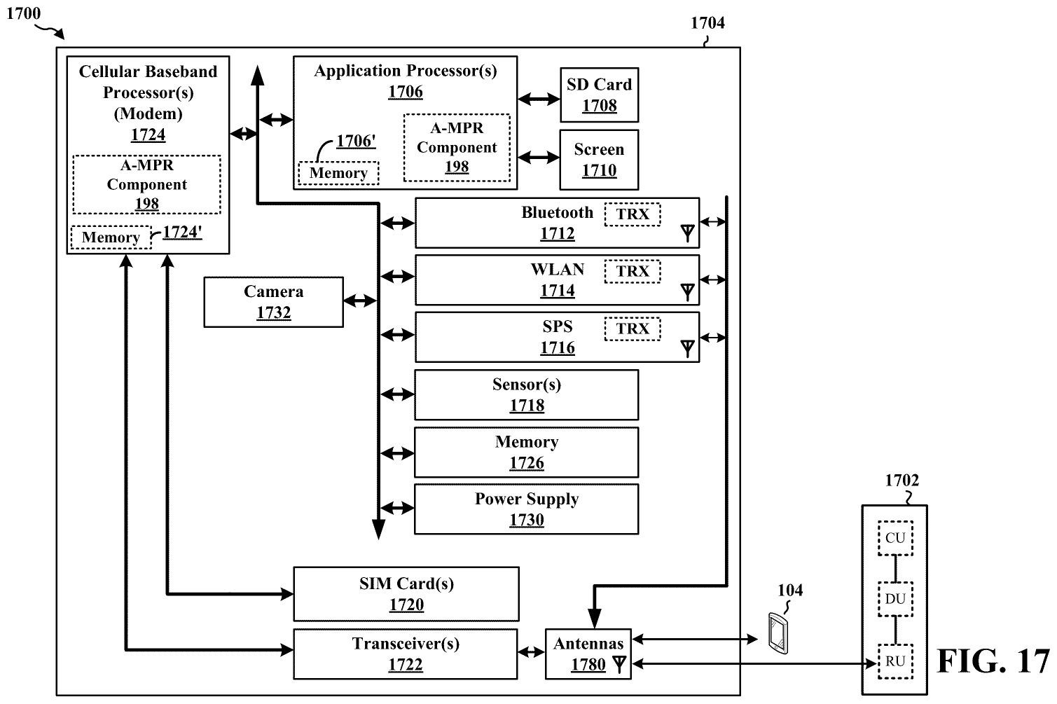

At 1202, the UE transmits, to a network node, A-MPR information associated with the UE for one or more waveforms. For example, the A-MPR information may be A-MPR supported by the UE. In some aspects, the A-MPR information may indicate UE specific A-MPR information. In some aspects, the network node is an NTN node. In some aspects, the network node may be a terrestrial node. In some aspects, the A-MPR information associated with the UE indicates at least one of an A-MPR region of frequency resources for the one or more waveforms and a non-A-MPR region of the frequency resources for the one or more waveforms. In some aspects, the non-A-MPR region includes a subset of the frequency resources for the one or more waveforms that the UE supports without a power backoff. The transmission may be performed, e.g., by one or more of the A-MPR component 198, one or more transceivers 1722, and/or one or more antennas 1780, such as in the apparatus 1704 in FIG. 17. FIG. 9 illustrates an example of a UE 902 transmitting A-MPR information to a network node 906.

At 1204, the UE communicates with the network node based on the A-MPR information associated with the UE. In some aspects, the UE receives a resource allocation in the non-A-MPR region of the frequency resources for the UE. To communicate, the UE may transmit an uplink transmission using frequency resources in the non-A-MPR region for the one or more waveforms. To communicate with the network node based on the A-MPR information associated with the UE, UE may receive a resource allocation with repetition in the A-MPR region of the frequency resources for the one or more waveforms. For example, the UE may receive a resource allocation with repetition based on the resource allocation overlapping at least partially with the A-MPR region of the frequency resources for the one or more waveforms. The UE may receive an additional resource allocation for additional uplink communication without repetition (or with fewer repetitions) based on the additional resource allocation being within a non-A-MPR region. The UE may receive an additional resource allocation having a few number repetitions based on the additional resources being allocated in frequency resources having a lower A-MPR than the resource allocation with repetition FIG. 10 illustrates an example of a UE 1002 that transmits an uplink transmission with repetition in an A-MPR region of frequency resources for a waveform. The communication may be performed, e.g., by one or more of the A-MPR component 198, one or more transceivers 1722, and/or one or more antennas 1780, such as in the apparatus 1704 in FIG. 17. For example, FIG. 9 illustrates an example of a UE 902 transmitting an uplink transmission, at 916, using frequency resources that are allocated based on the A-MPR information that the UE provided to the network node.

In some aspects, the UE may indicate support for an increased power class for a subset of waveforms. The UE may further receive a resource allocation in an A-MPR region of frequency resources for the one or more waveforms for which the UE supports the increased power class. FIG. 11 illustrates an example of a UE scheduled with a resource allocation based on an increased power class. The indication and/or the reception may be performed, e.g., by one or more of the A-MPR component 198, one or more transceivers 1722, and/or one or more antennas 1780, such as in the apparatus 1704 in FIG. 17.

FIG. 1300 is a flowchart 1300 of a method of wireless communication. The method may be performed by a UE (e.g., the UE 104, 204, 450, 504, 524, 605, 824, 826, 804, 806, 808, 902, 903, 1002, 1003, 1102, 1103; the apparatus 1704). The method may help to improve scheduling efficiency and/or reliability for uplink transmissions while meeting emissions requirements. In some aspects, the method may enable more efficient use of wireless resources by reducing the use of repetition resources by a targeted use of resources in an A-MPR region for a waveform for UEs that support a higher power class for the waveform.

At 1302, the UE transmits, to a network node, an indication of support for an increased power class for a subset of waveforms. As an example, the indication may indicate that the UE supports the increased power class is for the subset of waveforms of a larger set of possible waveforms. The transmission may be performed, e.g., by one or more of the A-MPR component 198, one or more transceivers 1722, and/or one or more antennas 1780, such as in the apparatus 1704 in FIG. 17. FIG. 11 illustrates an example of a UE 1102 indicating, to a network, a higher power class for a particular subset of waveforms.

At 1304, the UE receives, from the network node, scheduling information for a waveform in the subset of waveforms, the scheduling information indicating frequency resources in an A-MPR region of the waveform based on the support for the increased power class. The reception may be performed, e.g., by one or more of the A-MPR component 198, one or more transceivers 1722, and/or one or more antennas 1780, such as in the apparatus 1704 in FIG. 17. FIG. 11 illustrates an example of a UE 1102 receiving an allocation of frequency resources in an A-MPR region for a waveform based on the UE's higher power class for that waveform.

The UE may then transmit, with an increased transmission power, communication using the waveform and the frequency resources in the A-MPR region for the waveform. The transmission may be performed, e.g., by one or more of the A-MPR component 198, one or more transceivers 1722, and/or one or more antennas 1780, such as in the apparatus 1704 in FIG. 17. FIG. 11 illustrates an example of a UE 1102 transmitting an uplink transmission in an A-MPR region of frequency resources for a waveform with an increased transmission power, at 1112.

FIG. 1400 is a flowchart 1400 of a method of wireless communication. The method may be performed by a network node, such as a base station or one or more components of a base station (e.g., the base station 102, 202, 410, 502, 802; the CU 106, 210; the DU 105, 230; the RU 109, 240; the aerial device 522; one or more network nodes in FIG. 6A-6C; a network node at the satellite 822; network node 904, 1004, 1104; the network entity 1802). In some aspects, the network node is an NTN node. In some aspects, the network node may be a terrestrial node. The method may help to improve scheduling efficiency and/or reliability for uplink transmissions while meeting emissions requirements. The method helps to enable broader frequency band service to be provided to UEs, enabling an increased data rate and richer diversity of service.

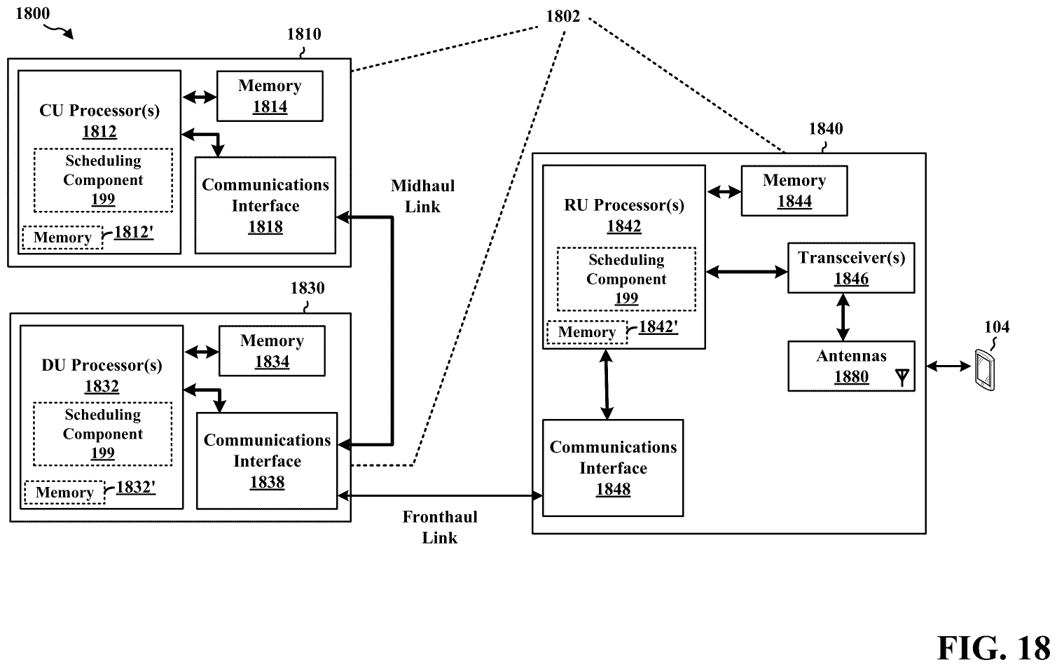

At 1402, the network node obtains A-MPR information associated with a UE for one or more waveforms. As an example, the network node may receive A-MPR information transmitted by a UE informing the network node of the UE specific A-MPR associated with the UE, e.g., in contrast to a defined A-MPR, for the waveform(s). The A-MPR information may indicate UE specific A-MPR information. The A-MPR information associated with the UE may indicate at least one of an A-MPR region of frequency resources for the one or more waveforms and a non-A-MPR region of the frequency resources for the one or more waveforms. The non-A-MPR region may include a subset of the frequency resources for the one or more waveforms that the UE supports without a power backoff. FIG. 9 illustrates an example of a network node 904 receiving UE specific A-MPR information from a UE 902. The obtaining may be performed, e.g., by one or more of the scheduling component 199, one or more transceivers 1846, and/or one or more antennas 1880, such as in the network entity 1802 in FIG. 18.

At 1404, the network node schedules communication from the UE based on the A-MPR information associated with the UE. For example, the network node may allocate frequency resources for uplink transmissions from the UE based on the UE specific A-MPR information. FIG. 9 illustrates an example of a network node 904 scheduling frequency resources for a UE 902 based on A-MPR information that the network node received from the UE. The scheduling may be performed, e.g., by one or more of the scheduling component 199, one or more transceivers 1846, and/or one or more antennas 1880, such as in the network entity 1802 in FIG. 18.

In some aspects, to schedule the communication from the UE based on the A-MPR information associated with the UE, the network node may schedule the communication from the UE in the non-A-MPR region of the frequency resources for the one or more waveforms. In some aspects, to schedule the communication from the UE based on the A-MPR information associated with the UE, the network node may schedule the communication from the UE with repetition in the A-MPR region of the frequency resources for the one or more waveforms. FIG. 10 illustrates an example of a network node 1004 scheduling a UE 1002 with repetition in an A-MPR region of frequency resources for waveform.

In some aspects, the network node may obtain an indication of support of the UE for an increased power class for a subset of waveforms. In some aspects, to schedule the communication from the UE based on the A-MPR information associated with the UE, the network node may schedule the communication from the UE in an A-MPR region of frequency resources for the one or more waveforms for which the UE supports the increased power class. FIG. 11 illustrates an example of a network node 1104 scheduling a UE 1102 in an A-MPR region of frequency resources for a waveform based on the UE's support of a higher power class for that waveform.

FIG. 1500 is a flowchart 1500 of a method of wireless communication. The method may be performed by a network node, such as a base station or one or more components of a base station (e.g., the base station 102, 202, 410, 502, 802; the CU 106, 210; the DU 105, 230; the RU 109, 240; the aerial device 522; one or more network nodes in FIG. 6A-6C; a network node at the satellite 822; network node 904, 1004, 1104; the network entity 1802). In some aspects, the network node is an NTN node. In some aspects, the network node may be a terrestrial node. The method may help to improve scheduling efficiency and/or reliability for uplink transmissions while meeting emissions requirements. In some aspects, the method may enable more efficient use of wireless resources by using A-MPR frequency resources for UE that support a higher power class for a corresponding waveform.

At 1502, the network node obtains an indication of support of a UE for an increased power class for a subset of waveforms. In some aspects, the indication of the support for the increased power class may be for the subset of waveforms from a larger set of possible waveforms. For example, the power class may apply for some waveforms and not for other waveforms. FIG. 11 illustrates an example of a network node 1104 receiving an indication of a higher power class from a UE 1102. The obtaining may be performed, e.g., by one or more of the scheduling component 199, one or more transceivers 1846, and/or one or more antennas 1880, such as in the network entity 1802 in FIG. 18.

At 1504, the network node schedules, based on the support for the increased power class, communication from the UE in frequency resources in an A-MPR region of the frequency resources for a waveform. FIG. 11 illustrates an example of a network node 1104 scheduling a UE 1102 with frequency resources in an A-MPR region for a waveform based on the UE's support of a higher power class for the waveform. The scheduling may be performed, e.g., by one or more of the scheduling component 199, one or more transceivers 1846, and/or one or more antennas 1880, such as in the network entity 1802 in FIG. 18.

In some aspects, the network node may further schedule one or more UEs that support a non-increased power class in a non-A-MPR region of the frequency resources for the waveform. For example, UEs that do not have the higher power class for the corresponding waveform may be scheduled in the non-A-MPR region. By reserving the use of the non-A-MPR region for UEs that have the lower power class, the network node can more efficiently schedule network frequency resources. The scheduling may be performed, e.g., by one or more of the scheduling component 199, one or more transceivers 1846, and/or one or more antennas 1880, such as in the network entity 1802 in FIG. 18.

FIG. 1600 is a flowchart 1600 of a method of wireless communication. The method may be performed by a network node, such as a base station or one or more components of a base station (e.g., the base station 102, 202, 410, 502, 802; the CU 106, 210; the DU 105, 230; the RU 109, 240; the aerial device 522; one or more network nodes in FIG. 6A-6C; a network node at the satellite 822; network node 904, 1004, 1104; the network entity 1802). In some aspects, the network node is an NTN node. In some aspects, the network node may be a terrestrial node. The method may help to improve scheduling efficiency and/or reliability for uplink transmissions while meeting emissions requirements. In some aspects, the method may enable more efficient use of wireless resources by reducing the use of repetition resources through a targeted use of repetition for UEs scheduled in an A-MPR region for a waveform.

At 1602, the network node schedules communication from a UE with repetition based on an A-MPR region of frequency resources for a waveform. FIG. 10 illustrates an example of a network node 1004 scheduling a UE 1002 with repetition and with frequency resources in an A-MPR region for a waveform. In some aspects, the A-MPR region and a non-A-MPR region may be defined, e.g., in a wireless standard. In some aspects, the network node may receive UE specific A-MPR information from a UE, such as described in connection with FIG. 9. The scheduling may be performed, e.g., by one or more of the scheduling component 199, one or more transceivers 1846, and/or one or more antennas 1880, such as in the network entity 1802 in FIG. 18. The scheduling may be based on the A-MPR region, as the network node may schedule communication with repetition (or more repetition) if the frequency resources of the scheduled communication are in the A-MPR region, and the network node may schedule communication without repetition (or with fewer repetitions) if the frequency resources of the scheduled communication are in a non-A-MPR region. As an additional example, the network node may schedule different amounts of repetition based on the A-MPR, e.g., scheduling a higher number of repetitions for communication in frequency resources associated with a higher amount of A-MPR, and scheduling a fewer number of repetitions for communication in frequency resources having a lower amount of A-MPR.

At 1604, the network node obtains the communication with the repetition. For example, the network node may receive one or more uplink transmissions based on the scheduling provided to the UE at 1602. FIG. 10 illustrates an example of a network node 1004 receiving an uplink transmission and a repetition of an uplink transmission in an A-MPR region of frequency resources for a waveform. The obtaining may be performed, e.g., by one or more of the scheduling component 199, one or more transceivers 1846, and/or one or more antennas 1880, such as in the network entity 1802 in FIG. 18.

In some aspects, the network node may further schedule additional uplink communication without the repetition in a non-A-MPR region of the frequency resources for the waveform.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 (or processor circuitry) may include at least one on-chip memory 1724′ (or memory circuitry). In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 (or processor circuitry) communicates through the transceiver(s) 1722 via one or more antennas 1780 with the UE 104 and/or with an RU associated with a network entity 1702. The cellular baseband processor(s) 1724 and the application processor(s) 1706 (or processor circuitry) may each include a computer-readable medium/memory 1724′, 1706′ (or memory circuitry), respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The cellular baseband processor(s) 1724 and the application processor(s) 1706 are configured to perform the various functions described supra based at least in part of the information stored in the memory. That is, the cellular baseband processor(s) 1724 and the application processor(s) 1706 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 450 and may include the at least one memory 460 and/or at least one of the TX processor 468, the RX processor 456, and the controller/processor 459. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 450 of FIG. 4) and include the additional modules of the apparatus 1704.

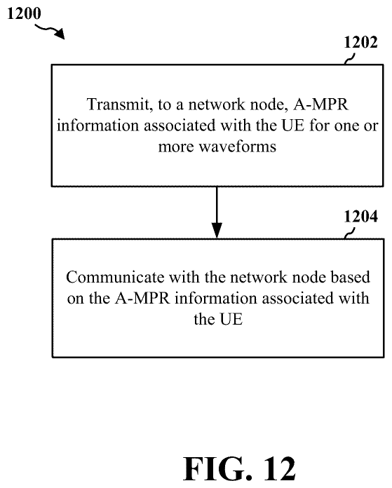

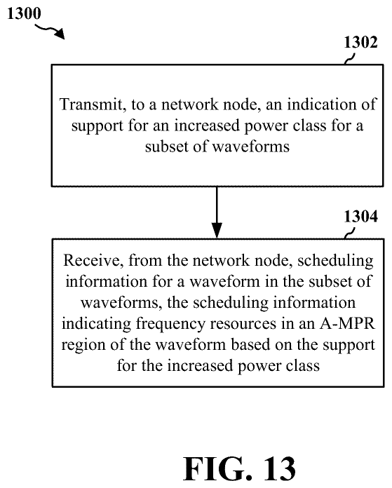

As discussed supra, the A-MPR component 198 may be configured to transmit, to a network node, A-MPR information associated with the UE for one or more waveforms; and communicate with the network node based on the A-MPR information associated with the UE. The A-MPR component 198 may be configured to receive a resource allocation in the non-A-MPR region of the frequency resources for the UE. The A-MPR component 198 may be configured to receive a resource allocation with repetition based on the resource allocation overlapping at least partially with the A-MPR region of the frequency resources for the one or more waveforms. The A-MPR component 198 may be configured to indicate support for an increased power class for a subset of waveforms. The A-MPR component 198 may be configured to receive a resource allocation in an A-MPR region of frequency resources for the waveform for which the UE supports the increased power class. The A-MPR component 198 may be configured to transmit, to a network node, an indication of support for an increased power class for a subset of waveforms; and receive, from the network node, scheduling information for a waveform in the subset of waveforms, the scheduling information indicating frequency resources in an A-MPR region of the waveform based on the support for the increased power class. The A-MPR component 198 may be configured to transmit, with an increased transmission power, communication using the waveform and the frequency resources in the A-MPR region for the waveform. The A-MPR component 198 may be further configured to perform any of the aspects described in connection with the flowchart in FIG. 12 or FIG. 13, and/or any of the aspects performed by a UE in any of FIGS. 9, 10, and/or 11. The A-MPR component 198 may be within the cellular baseband processor(s) 1724, the application processor(s) 1706, or both the cellular baseband processor(s) 1724 and the application processor(s) 1706. The A-MPR component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for transmitting, to a network node, A-MPR information associated with the UE for one or more waveforms; and means for communicating with the network node based on the A-MPR information associated with the UE. The apparatus may further include means for receiving a resource allocation in the non-A-MPR region of the frequency resources for the UE. The apparatus may further include means for receiving a resource allocation with repetition based on the resource allocation overlapping at least partially with the A-MPR region of the frequency resources for the one or more waveforms. The apparatus may further include means for indicating support for an increased power class for a subset of waveforms. The apparatus may further include means for receiving a resource allocation in an A-MPR region of frequency resources for the waveform for which the UE supports the increased power class. The apparatus may include means for transmitting, to a network node, an indication of support for an increased power class for a subset of waveforms; and means for receiving, from the network node, scheduling information for a waveform in the subset of waveforms, the scheduling information indicating frequency resources in an A-MPR region of the waveform based on the support for the increased power class. The apparatus may further include means for transmitting, with an increased transmission power, communication using the waveform and the frequency resources in the A-MPR region for the waveform. The apparatus may further include means for performing any of the aspects described in connection with the flowchart in FIG. 12 or FIG. 13, and/or any of the aspects performed by a UE in any of FIGS. 9, 10, and/or 11. The means may be the A-MPR component 198 of the apparatus 1704 configured to perform the functions recited by the means. As described supra, the apparatus 1704 may include the TX processor 468, the RX processor 456, and the controller/processor 459. As such, in one configuration, the means may be the TX processor 468, the RX processor 456, and/or the controller/processor 459 configured to perform the functions recited by the means.

FIG. 18 is a diagram 1800 illustrating an example of a hardware implementation for a network entity 1802. The network entity 1802 may be a BS, a component of a BS, or may implement BS functionality. In some aspects, the network entity may be an NTN node. In some aspects, the network entity may be a node of a terrestrial network. The network entity 1802 may include at least one of a CU 1810, a DU 1830, or an RU 1840. For example, depending on the layer functionality handled by the scheduling component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include at least one CU processor 1812 (or processor circuitry). The CU processor(s) 1812 may include on-chip memory 1812′ (or memory circuitry). In some aspects, the CU 1810 may further include additional memory modules 1814 and a communications interface 1818. The CU 1810 communicates with the DU 1830 through a midhaul link, such as an F1 interface. The DU 1830 may include at least one DU processor 1832. The DU processor(s) 1832 (or processor circuitry) may include on-chip memory 1832′ (or memory circuitry). In some aspects, the DU 1830 may further include additional memory modules 1834 and a communications interface 1838. The DU 1830 communicates with the RU 1840 through a fronthaul link. The RU 1840 may include at least one RU processor 1842. The RU processor(s) 1842 (or processor circuitry) may include on-chip memory 1842′ (or memory circuitry). In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

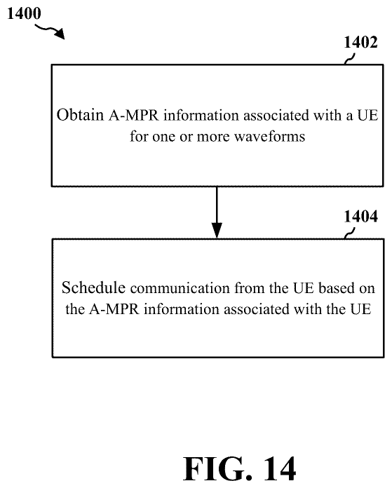

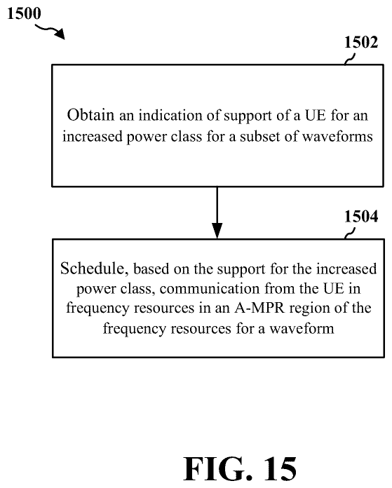

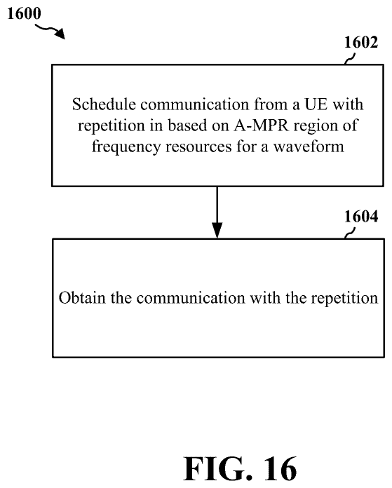

As discussed supra, the scheduling component 199 may be configured to obtain A-MPR information associated with a UE for one or more waveforms; and schedule communication from the UE based on the A-MPR information associated with the UE. The scheduling component 199 may be configured to schedule the communication from the UE in the non-A-MPR region of the frequency resources for the waveform. The scheduling component 199 may be configured to schedule the communication from the UE with repetition in the A-MPR region of the frequency resources for the waveform. The scheduling component 199 may be configured to obtain an indication of support of the UE for an increased power class for a subset of waveforms. The scheduling component 199 may be configured to schedule the communication from the UE in an A-MPR region of frequency resources for the waveform for which the UE supports the increased power class. The scheduling component 199 may be configured to obtain an indication of support of a UE for an increased power class for a subset of waveforms; and schedule, based on the support for the increased power class, communication from the UE in frequency resources in an A-MPR region of the frequency resources for the waveform. The scheduling component 199 may be configured to schedule one or more UEs that support a non-increased power class in a non-A-MPR region of the frequency resources for the waveform. The scheduling component 199 may be configured to schedule communication from a UE with repetition in an A-MPR region of frequency resources for a waveform; and obtain the communication with the repetition. The scheduling component 199 may be configured to schedule additional uplink communication without the repetition in a non-A-MPR region of the frequency resources for the waveform. The scheduling component 199 may be further configured to perform any of the aspects described in connection with the flowchart in FIG. 14, FIG. 15, and/or FIG. 16, and/or any of the aspects performed by the network node in any of FIGS. 9, 10, and/or 11. The scheduling component 199 may be within one or more processors of one or more of the CU 1810, DU 1830, and the RU 1840. The scheduling component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1802 may include a variety of components configured for various functions. In one configuration, the network entity 1802 may include means for obtaining A-MPR information associated with a UE for one or more waveforms; and means for scheduling communication from the UE based on the A-MPR information associated with the UE. The means for scheduling may schedule the communication from the UE in the non-A-MPR region of the frequency resources for the waveform. The means for scheduling may schedule the communication from the UE with repetition in the A-MPR region of the frequency resources for the waveform. The network entity may include means for obtaining an indication of support of the UE for an increased power class for a subset of waveforms. The means for scheduling may schedule the communication from the UE in an A-MPR region of frequency resources for the waveform for which the UE supports the increased power class. The network entity may include means for obtaining an indication of support of a UE for an increased power class for a subset of waveforms; and means for scheduling, based on the support for the increased power class, communication from the UE in frequency resources in an A-MPR region of the frequency resources for the waveform. The network entity may include means for scheduling one or more UEs that support a non-increased power class in a non-A-MPR region of the frequency resources for the waveform. The network entity may include means for scheduling communication from a UE with repetition in an A-MPR region of frequency resources for a waveform; and means for obtaining the communication with the repetition. The network entity may include means for scheduling additional uplink communication without the repetition in a non-A-MPR region of the frequency resources for the waveform. The network entity may further include means for performing any of the aspects described in connection with the flowchart in FIG. 14, FIG. 15, and/or FIG. 16, and/or any of the aspects performed by the network node in any of FIGS. 9, 10, and/or 11. The means may be the scheduling component 199 of the network entity 1802 configured to perform the functions recited by the means. As described supra, the network entity 1802 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: transmitting, to a network node, A-MPR information associated with the UE for one or more waveforms; and communicating with the network node based on the A-MPR information associated with the UE.

Aspect 2 is the method of aspect 1, wherein the A-MPR information indicates UE specific A-MPR information.

Aspect 3 is the method of any of aspects 1-2, wherein the network node is a non-terrestrial network (NTN) node.

Aspect 4 is the method of any of aspects 1-3, wherein the A-MPR information associated with the UE indicates at least one of an A-MPR region of frequency resources for the one or more waveforms and a non-A-MPR region of the frequency resources for the one or more waveforms.

Aspect 5 is the method of aspect 4, wherein the non-A-MPR region comprises a subset of the frequency resources for the one or more waveforms that the UE supports without a power backoff.

Aspect 6 is the method of aspect 4 or 5, wherein communicating with the network node based on the A-MPR information associated with the UE comprises: receiving a resource allocation in the non-A-MPR region of the frequency resources for the UE.

Aspect 7 is the method of aspect 4 or 5, wherein communicating with the network node based on the A-MPR information comprises: receiving a resource allocation with repetition based on the resource allocation overlapping at least partially with the A-MPR region of the frequency resources for the one or more waveforms.

Aspect 8 is the method of any of aspects 1-5, further comprising: indicating support for an increased power class for a subset of waveforms.

Aspect 9 is the method of aspect 8, wherein communicating with the network node based on the A-MPR information comprises: receiving a resource allocation in an A-MPR region of frequency resources for the one or more waveforms for which the UE supports the increased power class.

Aspect 10 is a method of wireless communication at a UE, comprising: transmitting, to a network node, an indication of support for an increased power class for a subset of waveforms; and receiving, from the network node, scheduling information for a waveform in the subset of waveforms, the scheduling information indicating frequency resources in an A-MPR region of the waveform based on the support for the increased power class.

Aspect 11 is the method of aspect 10, further comprising: transmitting, with an increased transmission power, communication using the waveform and the frequency resources in the A-MPR region for the waveform.

Aspect 12 is the method of aspect 10 or 11, wherein the indication indicates that the UE supports the increased power class is for the subset of waveforms of a larger set of possible waveforms.

Aspect 13 is a method of wireless communication at a network node, comprising: obtaining A-MPR information associated with a UE for one or more waveforms; and scheduling communication from the UE based on the A-MPR information associated with the UE.

Aspect 14 is the method of aspect 13, wherein the network node is an NTN node.

Aspect 15 is the method of aspect 13 or 14, wherein the A-MPR information indicates UE specific A-MPR information.

Aspect 16 is the method of any of aspects 13-15, wherein the A-MPR information associated with the UE indicates at least one of an A-MPR region of frequency resources for the one or more waveforms and a non-A-MPR region of the frequency resources for the one or more waveforms.

Aspect 17 is the method of aspect 16, wherein the non-A-MPR region comprises a subset of the frequency resources for the one or more waveforms that the UE supports without a power backoff.

Aspect 18 is the method of aspect 16 or 17, wherein scheduling the communication from the UE based on the A-MPR information associated with the UE comprises: scheduling the communication from the UE in the non-A-MPR region of the frequency resources for the one or more waveforms.

Aspect 19 is the method of aspect 16 or 17, wherein scheduling the communication from the UE based on the A-MPR information associated with the UE comprises: scheduling the communication from the UE with repetition in the A-MPR region of the frequency resources for the one or more waveforms.

Aspect 20 is the method of aspect any of aspects 13-16, further comprising: obtaining an indication of support of the UE for an increased power class for a subset of waveforms.

Aspect 21 is the method of aspect 20, wherein scheduling the communication from the UE based on the A-MPR information associated with the UE comprises: scheduling the communication from the UE in an A-MPR region of frequency resources for the one or more waveforms for which the UE supports the increased power class.

Aspect 22 is a method of wireless communication at network node, comprising: obtaining an indication of support of a UE for an increased power class for a subset of waveforms; and scheduling, based on the support for the increased power class, communication from the UE in frequency resources in an A-MPR region of the frequency resources for the waveform.

Aspect 23 is the method of aspect 22, further comprising: scheduling one or more UEs that support a non-increased power class in a non-A-MPR region of the frequency resources for the waveform.

Aspect 24 is the method of aspect 22 or 23, wherein the indication of the support for the increased power class is for the subset of waveforms from a larger set of possible waveforms.

Aspect 25 is a method of wireless communication at a network node, comprising: scheduling communication from a UE with repetition based on an A-MPR region of frequency resources for a waveform; and obtaining the communication with the repetition.

Aspect 26 is the method of aspect 25, further comprising: scheduling additional uplink communication without the repetition in a non-A-MPR region of the frequency resources for the waveform.

Aspect 27 is the method of aspect 25 or 26, further including scheduling additional uplink communication with fewer repetitions than the communication scheduled with repetition based on the uplink communication being scheduled for first frequency resources associated with a higher A-MPR than second frequency resources scheduled for the additional uplink communication.

Aspect 28 is the method of any of aspects 25-27, wherein the A-MPR region and a non-A-MPR region are defined.

Aspect 29 is an apparatus for wireless communication at a UE, comprising: one or more memories; and one or more processors coupled to the one or more memories and configured to cause the UE to perform the method of any of aspects 1-9.

Aspect 30 is an apparatus for wireless communication at a UE, comprising means for performing each step in the method of any of aspects 1-9.

Aspect 31 is the apparatus of any of aspects 29 to 30, further comprising a transceiver configured to receive or to transmit in association with the method of any of aspects 1-9.

Aspect 32 is a computer-readable storage medium (e.g., a non-transitory computer-readable storage medium) storing computer executable code at a UE, the code when executed by at least one processor causes the UE to perform the method of any of aspects 1-9

Aspect 33 is an apparatus for wireless communication at a UE, comprising: one or more memories; and one or more processors coupled to the one or more memories and configured to cause the UE to perform the method of any of aspects 10-12.

Aspect 34 is an apparatus for wireless communication at a UE, comprising means for performing each step in the method of any of aspects 10-12.

Aspect 35 is the apparatus of any of aspects 34 to 35, further comprising a transceiver configured to receive or to transmit in association with the method of any of aspects 10-12.

Aspect 36 is a computer-readable storage medium (e.g., a non-transitory computer-readable storage medium) storing computer executable code at a UE, the code when executed by at least one processor causes the UE to perform the method of any of aspects 10-12.

Aspect 37 is an apparatus for wireless communication at a network node, comprising: one or more memories; and one or more processors coupled to the one or more memories and configured to cause the network node to perform the method of any of aspects 13-21.

Aspect 38 is an apparatus for wireless communication at a network node, comprising means for performing each step in the method of any of aspects 13-21.

Aspect 39 is the apparatus of any of aspects 37 to 38, further comprising a transceiver configured to receive or to transmit in association with the method of any of aspects 13-21.

Aspect 40 is a computer-readable storage medium (e.g., non-transitory computer-readable storage medium) storing computer executable code at a network node, the code when executed by at least one processor causes the network node to perform the method of any of aspects 13-21.

Aspect 41 is an apparatus for wireless communication at a network node, comprising: one or more memories; and one or more processors coupled to the one or more memories and configured to cause the network node to perform the method of any of aspects 22-24.

Aspect 42 is an apparatus for wireless communication at a network node, comprising means for performing each step in the method of any of aspects 22-24.

Aspect 43 is the apparatus of any of aspects 41 to 42, further comprising a transceiver configured to receive or to transmit in association with the method of any of aspects 22-24.

Aspect 44 is a computer-readable storage medium (e.g., a non-transitory computer-readable storage medium) storing computer executable code at a network node, the code when executed by at least one processor causes the network node to perform the method of any of aspects 22-24.

Aspect 45 is an apparatus for wireless communication at a network node, comprising: one or more memories; and one or more processors coupled to the one or more memories and configured to cause the network node to perform the method of any of aspects 25-28.

Aspect 45 is an apparatus for wireless communication at a network node, comprising means for performing each step in the method of any of aspects 25-28.

Aspect 46 is the apparatus of any of aspects 45 to 46, further comprising a transceiver configured to receive or to transmit in association with the method of any of aspects 25-28.

Aspect 48 is a computer-readable storage medium (e.g., a non-transitory computer-readable storage medium) storing computer executable code at a network node, the code when executed by at least one processor causes the network node to perform the method of any of aspects 25-28.

Aspect 49 is a UE comprising: a processing system that includes processor circuitry and memory circuitry that stores code and is coupled with the processor circuitry, the processing system configured to cause the UE to: perform the method of any of aspects 1-9.

Aspect 50 is a UE comprising: a processing system that includes processor circuitry and memory circuitry that stores code and is coupled with the processor circuitry, the processing system configured to cause the UE to: perform the method of any of aspects 10-12.

Aspect 51 is a network node comprising: a processing system that includes processor circuitry and memory circuitry that stores code and is coupled with the processor circuitry, the processing system configured to cause the network node to: perform the method of any of aspects 13-21.

Aspect 52 is a network node comprising: a processing system that includes processor circuitry and memory circuitry that stores code and is coupled with the processor circuitry, the processing system configured to cause the network node to: perform the method of any of aspects 22-24.

Aspect 53 is a network node comprising: a processing system that includes processor circuitry and memory circuitry that stores code and is coupled with the processor circuitry, the processing system configured to cause the network node to: perform the method of any of aspects 25-28.

What is claimed is:

1. An apparatus for wireless communication at a user equipment (UE), comprising:
one or more memories; and
one or more processors coupled to the one or more memories and, the one or more processors, configured to cause the UE to:
transmit, to a network node, additional maximum power reduction (A-MPR) information associated with the UE for one or more waveforms; and
communicate with the network node based on the A-MPR information associated with the UE.

2. The apparatus of claim 1, wherein the apparatus further includes one or more antennas coupled to the one or more processors, and the A-MPR information indicates UE specific A-MPR information.

3. The apparatus of claim 1, wherein the network node is a non-terrestrial network (NTN) node.

4. The apparatus of claim 1, wherein the A-MPR information associated with the UE indicates at least one of an A-MPR region of frequency resources for the one or more waveforms and a non-A-MPR region of the frequency resources for the one or more waveforms.

5. The apparatus of claim 4, wherein the non-A-MPR region comprises a subset of the frequency resources for the one or more waveforms that the UE supports without a power backoff.

6. The apparatus of claim 4, wherein to communicate with the network node based on the A-MPR information associated with the UE, the one or more processors are configured to cause the UE to:
receive a resource allocation in the non-A-MPR region of the frequency resources for the UE.

7. The apparatus of claim 4, wherein to communicate with the network node based on the A-MPR information associated with the UE, the one or more processors are configured to cause the UE to:
receive a resource allocation with repetition based on the resource allocation that overlaps at least partially with the A-MPR region of the frequency resources for the one or more waveforms.

8. The apparatus of claim 1, wherein the one or more processors, individually or in any combination, are further configured to cause the UE to:
indicate support for an increased power class for a subset of waveforms.

9. The apparatus of claim 8, wherein to communicate with the network node based on the A-MPR information associated with the UE, the one or more processors are configured to cause the UE to:
receive a resource allocation in an A-MPR region of frequency resources for the one or more waveforms for which the UE supports the increased power class.

10. An apparatus for wireless communication at a user equipment (UE), comprising:
one or more memories; and
one or more processors coupled to the one or more memories, the one or more processors configured to cause the UE to:
transmit, to a network node, an indication of support for an increased power class for a subset of waveforms; and
receive, from the network node, scheduling information for a waveform in the subset of waveforms, wherein the scheduling information indicates frequency resources in an additional maximum power reduction (A-MPR) region of the waveform based on the support for the increased power class.

11. The apparatus of claim 10, wherein the one or more processors are further configured to cause the UE to:
transmit, with an increased transmission power, communication using the waveform and the frequency resources in the A-MPR region for the waveform.

12. The apparatus of claim 10, wherein the apparatus further includes one or more antennas coupled to the one or more processors, and the indication indicates that the UE supports the increased power class is for the subset of waveforms of a larger set of possible waveforms.

13. An apparatus for wireless communication at a network node, comprising:
one or more memories; and
one or more processors coupled to the one or more memories and, the one or more processors, configured to cause the network node to:
obtain additional maximum power reduction (A-MPR) information associated with a user equipment (UE) for one or more waveforms; and
schedule communication from the UE based on the A-MPR information associated with the UE.

14. The apparatus of claim 13, wherein the network node is a non-terrestrial network (NTN) node.

15. The apparatus of claim 13, wherein the A-MPR information indicates UE specific A-MPR information.

16. The apparatus of claim 13, wherein the A-MPR information associated with the UE indicates at least one of an A-MPR region of frequency resources for the one or more waveforms and a non-A-MPR region of the frequency resources for the one or more waveforms.

17. The apparatus of claim 16, wherein the non-A-MPR region comprises a subset of the frequency resources for the one or more waveforms that the UE supports without a power backoff.

18. The apparatus of claim 16, wherein to schedule the communication from the UE based on the A-MPR information associated with the UE, the one or more processors, are configured to cause the network node to:
schedule the communication from the UE in the non-A-MPR region of the frequency resources for the one or more waveforms.

19. The apparatus of claim 16, wherein to schedule the communication from the UE based on the A-MPR information associated with the UE, the one or more processors are configured to cause the network node to:
schedule the communication from the UE with repetition in the A-MPR region of the frequency resources for the one or more waveforms.

20. The apparatus of claim 13, wherein the one or more processors are further configured to cause the network node to:
obtain an indication of support of the UE for an increased power class for a subset of waveforms.

21. The apparatus of claim 20, wherein to schedule the communication from the UE based on the A-MPR information associated with the UE, the one or more processors are configured to cause the network node to:
schedule the communication from the UE in an A-MPR region of frequency resources for the one or more waveforms for which the UE supports the increased power class.

22. The apparatus of claim 13, wherein the apparatus further includes one or more antennas coupled to the one or more processors.

23. An apparatus for wireless communication at a network node, comprising:
one or more memories; and
one or more processors coupled to the one or more memories, the one or more processors configured to cause the network node to:
obtain an indication of support of a user equipment (UE) for an increased power class for a subset of waveforms; and
schedule, based on the support for the increased power class, communication from the UE in frequency resources in an additional maximum power reduction (A-MPR) region of the frequency resources for a waveform.

24. The apparatus of claim 23, wherein the one or more processors are further configured to cause the network node to:
schedule one or more UEs that support a non-increased power class in a non-A-MPR region of the frequency resources for the waveform.

25. The apparatus of claim 23, wherein the indication of the support for the increased power class is for the subset of waveforms from a larger set of possible waveforms.

26. The apparatus of claim 23, wherein the apparatus further includes one or more antennas coupled to the one or more processors.

27. An apparatus for wireless communication at a network node, comprising:
one or more memories; and
one or more processors coupled to the one or more memories, the one or more processors configured to cause the network node to:
schedule communication from a user equipment (UE) with repetition based on an additional maximum power reduction (A-MPR) region of frequency resources for a waveform; and
obtain the communication with the repetition.

28. The apparatus of claim 27, wherein the apparatus further includes one or more antennas coupled to the one or more processors, and wherein the one or more processors are further configured to cause the network node to:
schedule additional uplink communication without the repetition in a non-A-MPR region of the frequency resources for the waveform.

29. The apparatus of claim 27, wherein the one or more processors are further configured to cause the network node to:
schedule additional uplink communication with fewer repetitions than the communication scheduled with the repetition based on the communication being scheduled for first frequency resources associated with a higher A-MPR than second frequency resources scheduled for the additional uplink communication.

30. The apparatus of claim 27, wherein the A-MPR region and a non-A-MPR region are defined.
